(19) United States
(12) Patent Application Publication
(10) Pub. No.: US 2026/0249317 A1
(43) Pub. Date: Aug. 27, 2026

(54) SPRAY GUN COMPONENT WITH RESILIENT FLOW CONTROL VALVE

(71) Applicant: 3M INNOVATIVE PROPERTIES COMPANY, St. Paul, MN (US)

(72) Inventors: Ryan D. Erickson, Roseville, MN (US); Bryan J. Hayward, St. Paul, MN (US); Stephen C.P. Joseph, Woodbury, MN (US); Scott D. Gullicks, River Falls, WI (US)

(21) Appl. No.: 18/877,244

(22) PCT Filed: Jun. 30, 2023
(86) PCT No.: PCT/IB2023/056877

§ 371 Date: Dec. 19, 2024

Related U.S. Application Data
(60) Provisional application No. 63/358,043, filed on Jul. 1, 2022.

(51) Int. Cl. B05B 12/08; B05B 7/24

(52) U.S. Cl. CPC B05B 12/087; B05B 7/2408; B05B 7/2424; B05B 7/2478

(57) ABSTRACT

Aspects of the present disclosure relate to a spray gun component for use in a spray gun system. The spray gun component can include a spray gun component body further including a liquid inlet and a liquid outlet. At least a portion of a resilient flow control valve is disposed within a liquid passageway formed between the liquid inlet and liquid outlet. The resilient flow control valve having an upstream side and a downstream side. The upstream side is configured to be in fluid communication with the liquid inlet and the downstream side is in fluid communication with atmosphere. In a second mode, gas flow from the spray gun system causes the differential pressure across the resilient flow control valve to be at least the opening pressure of the resilient flow control valve and thereby causes the resilient flow control valve to change to an open configuration.

### BACKGROUND

Spray equipment is used in many processes including surface coating applications, combustion, and chemical reaction control. Spray equipment can include devices that transform bulk liquids into a fine spray or mist of droplets. The size and shape of spray equipment can depend upon the desired application and/or delivery system. Applications over the years have included delivery of gas hydrocarbon feeds in fluidized catalytic cracking processes, dispensing of chemical insecticides, and application of protective or aesthetic surface coatings.

Spray equipment can be used, for example, in vehicle repair body shops to apply liquid coating media such as primer, paint and/or clearcoat to vehicle parts. Spray equipment such as a spray gun can be made of a combination of metal and polymeric materials and includes a platform and spray head assembly. The spray head assembly includes a nozzle for dispensing the liquid, one or more atomizing gas outlets to atomize the liquid as it exits the nozzle, and two or more shaping gas outlets to shape the atomized liquid into the desired spray pattern. The spray gun contains a series of internal passages that distribute gas from a gas supply manifold in the platform to the atomizing gas outlet(s) and shaping gas outlets in the spray head assembly. Such spray guns are sometimes referred to as the air-atomizing, air-spray, air-assist, or air-blast type.

### BRIEF SUMMARY

In some designs, manually-operated valves such as a needle valve are used to control the flow of coating liquid through the spray gun (see for example, FIG. 1 and FIG. 2). The needle (or valve stem) is located along a central axis of the nozzle and shuts off on the valve seat near the outlet orifice. The needle/stem is typically connected to a trigger as a means of actuation by the user's hand. When the trigger is pulled back by the user, the needle will slide away from the valve seat and allow liquid to flow through the passage outlet. When the trigger is released, a spring is used to push the needle back to its closed position in contact with the valve seat. Along the length of the needle, seals (or packings) are used to isolate liquid within the flow passage from the external region of the spray gun.

These components found in the aforementioned spray gun are known to require tight manufacturing tolerances, contribute appreciably to the cost of the spray gun, wear down over time due to cycling, and require routine cleaning and maintenance by the user.

Aspects of the present disclosure relate to a spray gun component for use in a spray gun system. The spray gun component can include a spray gun component body further including a liquid inlet and a liquid outlet. A liquid passageway is formed between the liquid inlet and liquid outlet.

At least a portion of a resilient flow control valve is disposed within the liquid passageway. The resilient flow control valve having an upstream side and a downstream side. The upstream side is configured to be in fluid communication with the liquid inlet and the downstream side is in fluid communication with atmosphere. In at least one embodiment, a resilient flow control valve is a type of indirectly actuated valve which may be opened or closed via differential pressure across the valve and is distinct from manually-operated valves.

In a first mode, a differential pressure across the resilient flow control valve is less than an opening pressure of the resilient flow control valve and results in a closed configuration. In a second mode, gas flow from the spray gun system causes the differential pressure across the resilient flow control valve to be at least the opening pressure of the resilient flow control valve and thereby causes the resilient flow control valve to change to an open configuration.

In at least one embodiment, the resilient flow control valve has a resilient portion with a dimension measured in a plane transverse to the resilient flow control valve axis and the differential pressure is measured at no greater than the dimension both upstream and downstream from an opening of the resilient portion.

In at least one embodiment, in the first mode, the spray gun system is not discharging gas at a mixing zone.

In at least one embodiment, the spray gun system does not use a needle valve within the liquid passageway to control the flow of liquid.

In at least one embodiment, the only device for controlling a passage of fluid between the liquid inlet and the liquid outlet is one or more resilient flow control valves.

In at least one embodiment, spray gun system is not configured to operate with a manually-operated valve that seals the liquid passageway from atmosphere in the first mode or unseals the liquid passageway from the atmosphere in the second mode.

In at least one embodiment, the manually-operated valve is a globe valve, gate valve, ball valve, butterfly valve, plug valve, slide valve, a needle valve, or a pinch-valve.

In at least one embodiment, the resilient flow control valve is disposed proximate to the liquid outlet.

In at least one embodiment, the resilient flow control valve forms part of the liquid outlet.

In at least one embodiment, the resilient flow control valve is configured to close when the differential pressure across the resilient flow control valve is less than a closing pressure of the resilient flow control valve.

In at least one embodiment, the resilient flow control valve opens in one-direction.

In at least one embodiment, the downstream side of the resilient flow control valve is below atmospheric pressure in the second mode.

In at least one embodiment, the downstream side is above atmospheric pressure in the second mode.

In at least one embodiment, pressure on the upstream side of the resilient flow control valve is augmented by gas pressure from a compatible spray gun body or a gas source.

In at least one embodiment, activation of a gas valve in a spray gun platform causes the resilient flow control valve to open by increasing the pressure on the upstream side of the resilient flow control valve which increases differential pressure across the resilient flow control valve.

In at least one embodiment, the flow of gas at a mixing zone reduces pressure on the downstream side of the resilient flow control valve causing a resilient portion to form an opening when the differential pressure is at least the opening pressure of the resilient flow control valve.

In at least one embodiment, the spray gun component further includes a gas inlet and a gas outlet. A gas passageway is formed between the gas inlet and gas outlet therein. In at least one embodiment, the upstream side of the resilient flow control valve is fluidically isolated from the gas passageway.

In at least one embodiment, the spray gun component can include a removable cover configured to form part of the gas passageway and/or liquid passageway.

In at least one embodiment, the liquid passageway further comprises a retention structure configured to engage with the resilient flow control valve. In at least one embodiment, the retention structure includes a rim forming an opening therein.

In at least one embodiment, the retention structure has the upstream side and the downstream side. The downstream side of the resilient flow control valve is configured to contact the upstream side of the retention structure.

In at least one embodiment, the spray gun component includes a baffle comprising a wall with an opening formed therein. The baffle can be configured to form a fluid-tight seal with a retention structure and/or the resilient flow control valve.

In at least one embodiment, the spray gun component includes a tubular wall configured to form a fluid-tight seal using the retention structure.

In at least one embodiment, the spray gun component is a nozzle assembly.

In at least one embodiment, the spray gun component can include an air cap disposed thereon. In at least one embodiment, the spray gun component is configured to mate with a spray gun platform. The spray gun platform can include a second gas passageway formed in a spray gun body therein. The spray gun component has the liquid passageway formed therein. In at least one embodiment, the spray gun component comprises a gas passageway formed between a gas inlet and a gas outlet therein. The gas inlet of the spray gun component can be configured to mate with the gas passageway in the spray gun platform. In at least one embodiment, the nozzle assembly is a nozzle cartridge.

In at least one embodiment, a mixing zone is formed outside of the spray gun component where the streams of gas and liquid pass through their respective outlets and merge.

In at least one embodiment, the gas and the liquid remain separated in their distinct passages until passing through their respective outlets at the mixing zone.

In at least one embodiment, the liquid passageway comprises a downstream liquid chamber. A retention structure can form a downstream liquid chamber in the liquid passageway. The downstream side of the resilient flow control valve can face a downstream liquid chamber. In at least one embodiment, the downstream liquid chamber comprises a plurality of chamber sections that are oblique to each other. A chamber section is coaxial with a longitudinal axis.

In at least one embodiment, a dimension of the downstream liquid chamber is no greater than 3 times a dimension of the resilient flow control valve.

In at least one embodiment, a gas chamber and a downstream liquid chamber are parallel with a longitudinal axis.

In at least one embodiment, the nozzle assembly comprises a nozzle comprising a distal surface. The upstream side of the resilient flow control valve can be configured to engage with the distal surface.

In at least one embodiment, the liquid inlet is configured to be fluidically coupled to a liquid reservoir system.

In at least one embodiment, the nozzle assembly is capable of being disassembled from a spray gun platform and retain a fluid-tight seal between atmosphere and contents of a liquid reservoir system.

In at least one embodiment, the liquid reservoir system is configured to be pressurized in the second mode by activation of a gas valve.

In at least one embodiment, the nozzle assembly comprises a boost passageway.

In at least one embodiment, the resilient flow control valve can include a frame structure and/or a resilient portion which may be attached to the frame structure. The frame structure can be configured to mate with the retention structure.

In at least one embodiment, openable portions are movable from the initially closed configuration to an open configuration when the resilient portion is subjected to the differential pressure that is at least the opening pressure.

In at least one embodiment, the resilient portion comprises at least one self-sealing opening formed therein.

In at least one embodiment, the self-sealing opening forms a slit, a cross, or a star-shaped pattern. In at least one embodiment, the slit is non-linear.

In at least one embodiment, the resilient flow control valve is entirely composed of an elastomeric material that is contained between two or more components which are permanently bonded.

In at least one embodiment, the liquid passageway is rigid.

In at least one embodiment, the spray gun component can be an integrated air cap/nozzle, wherein the liquid outlet and a gas outlet are formed in the integrated air cap/nozzle. The resilient flow control valve can be installed with the integrated air cap/nozzle and a mixing zone is formed where the liquid and gas streams interact.

In at least one embodiment, the spray gun component can be a liquid hose assembly.

In at least one embodiment, the spray gun component can be a liquid reservoir component including a spout, a connection format disposed on the liquid reservoir component for attaching to a complementary connection format on a spray gun/platform. In at least one embodiment, the spout includes the liquid inlet and the liquid outlet.

In at least one embodiment, the liquid reservoir component can be a lid configured to form a fluid-tight seal with a cup.

In at least one embodiment, the liquid reservoir component can be an adaptor configured to mate with a compatible lid.

In at least one embodiment, the resilient flow control valve is disposed adjacent to a distal surface of the spout.

In at least one embodiment, aspects of the present disclosure can relate to a spray gun that includes the spray gun component.

In at least one embodiment, aspects of the present disclosure can relate to a system that includes the spray gun component. The system can include a spray gun platform including a spray gun body. The spray gun component is configured to mechanically couple to the spray gun body.

In at least one embodiment, the system can include a liquid reservoir system configured to mechanically couple to the spray gun component.

In at least one embodiment, the spray gun platform can include a grip portion and a gas valve operable while a user is holding the grip portion. The gas valve controls the flow of a gas but does not manually actuate any valve within the liquid passageway.

In at least one embodiment, the spray gun platform has a top surface, the actuator is disposed on the top surface and is operable with the user's thumb. A gas valve is within the spray gun platform and coupled to the actuator.

In at least one embodiment, the actuator is disposed on a grip portion of the spray gun platform.

In at least one embodiment, the spray gun component is a nozzle assembly which can include a quick connect that is configured to mate with a complementary feature on the spray gun body.

In at least one embodiment, the nozzle assembly includes a nozzle tubular wall having a retention feature formed therein. The spray gun body can include a tubular wall operably connectable to a gas source at one end. The nozzle tubular wall can be configured to releasably mate with the tubular wall at an opposite end.

In at least one embodiment, the spray gun body can include a nozzle release mechanism that is mechanically coupled to the nozzle tubular wall. When activated, the nozzle release mechanism can cause the nozzle assembly to be removable from the spray gun body.

In at least one embodiment, aspects of the present disclosure can relate to a kit that includes the resilient flow control valve configured to operate with a spray gun system.

In at least one embodiment, the kit can include the spray gun component.

In at least one embodiment, the kit can include a spray gun platform, a nozzle assembly, and/or a liquid reservoir system.

In at least one embodiment, the kit can include a liquid stored in the liquid reservoir system.

In at least one embodiment, aspects of the present disclosure can relate to a method of using the spray gun component described herein. In at least one embodiment, the spray gun component is a nozzle assembly. The method can include obtaining the spray gun system that comprises a nozzle assembly body having a liquid inlet and a liquid outlet that form a liquid passageway and a gas inlet and a gas outlet that form a gas passageway. In at least one embodiment, the liquid outlet and gas outlet are configured to intersect at a mixing zone adjacent to the liquid outlet and the gas outlet. In at least one embodiment, a resilient flow control valve is disposed within the liquid passageway in a fluid-tight manner. In at least one embodiment, the spray gun system is coupled to a gas source that is controlled by an actuator. The method can include activating the actuator thus allowing gas to flow through the gas passageway and through the gas outlet. In response to activating the actuator, the flow of gas induces a change in a differential pressure across the resilient flow control valve. In at least one embodiment, the differential pressure exceeds an opening pressure of the resilient flow control valve and thereby causes the resilient flow control valve to change to an open configuration. The method can also include deactivating the actuator thus reducing the flow of gas through the gas passageway and reducing the differential pressure across the resilient flow control valve to no greater than a closing pressure of the resilient flow control valve thereby causing the resilient flow control valve to change to a closed configuration.

In at least one embodiment, aspects of the present disclosure can relate to a nozzle assembly that includes a nozzle assembly body. The nozzle assembly body further includes a gas passageway and a liquid passageway formed therein. The liquid passageway can be formed between a liquid inlet and a liquid outlet. In at least one embodiment, the liquid passageway is configured to fluidically couple to a liquid reservoir system configured to contain a liquid, and the gas passageway is configured to fluidically couple to a gas source. In at least one embodiment, a resilient flow control valve is disposed within the liquid passageway. In at least one embodiment, the resilient flow control valve has an upstream side and a downstream side. The upstream side is in fluid communication with the liquid reservoir system and the downstream side is in fluid communication with the liquid outlet. The gas flow through the gas passageway can open the resilient flow control valve in response to a difference in pressure across the first and second sides being at least an opening pressure of the resilient flow control valve, thus allowing the resilient flow control valve to open.

Aspects of the present disclosure relate to a system that includes the nozzle assembly, and a spray gun platform configured to mate with the nozzle assembly such that the gas passageway is coupled to a second gas passageway of the spray gun platform.

Aspects of the present disclosure relate to a lid for a liquid reservoir system that includes a lid body having a liquid inlet and a liquid outlet. The liquid inlet is configured to connect to a compatible cup and the liquid outlet configured to connect to a compatible spray gun system, or adapter, or spray gun platform. In at least one embodiment, a liquid passageway is formed in the lid body and fluidically connects the liquid inlet and the liquid outlet. In at least one embodiment, a resilient flow control valve is disposed within the liquid passageway. The resilient flow control valve can have a first side and a second side. In at least one embodiment, the first side is in fluid communication with the liquid inlet and the second side is in fluid communication with the liquid outlet. In at least one embodiment, gas flow through the compatible liquid spray gun system opens the resilient flow control valve when a difference in pressure across the first and second sides is equal to or exceeds an opening pressure of the resilient flow control valve.

In at least one embodiment, the resilient flow control valve is positioned adjacent to the liquid outlet.

In at least one embodiment, the resilient flow control valve is positioned adjacent to the liquid inlet.

In at least one embodiment, a spout can form a portion of the liquid passageway. In at least one embodiment, the spout has an interior surface having a retention structure disposed thereon configured to engage with the resilient flow control valve.

In at least one embodiment, the lid can include a spout that forms the liquid passageway. The spout can have a distal surface having the resilient flow control valve disposed thereon.

Aspects of the present disclosure relate to a method of operating a spray gun system. The method can include obtaining the spray gun system that comprises a nozzle assembly body having a liquid inlet and a liquid outlet that form a liquid passageway and a gas inlet and a gas outlet that form a gas passageway. In at least one embodiment, the liquid outlet and gas outlet are configured to intersect at a mixing zone adjacent to the liquid outlet and the gas outlet. In at least one embodiment, a resilient flow control valve is disposed within the liquid passageway in a fluid-tight manner. In at least one embodiment, the spray gun system is coupled to a gas source that is controlled by an actuator. The method can include activating the actuator thus allowing gas to flow through the gas passageway and through the gas outlet. In response to activating the actuator, the flow of gas induces a change in a differential pressure across the resilient flow control valve. In at least one embodiment, the differential pressure exceeds an opening pressure of the resilient flow control valve and thereby causes the resilient flow control valve to change to an open configuration. The method can also include deactivating the actuator thus reducing the flow of gas through the gas passageway and reducing the differential pressure across the resilient flow control valve to no greater than a closing pressure of the resilient flow control valve thereby causing the resilient flow control valve to change to a closed configuration.

In at least one embodiment, the method can include assembling the spray gun system by attaching the nozzle assembly body to a spray gun platform. In at least one embodiment, the spray gun platform comprises a second gas passageway that couples with the gas passageway in the nozzle assembly body. In at least one embodiment, the liquid passageway in the nozzle assembly body is separate from the gas passageway and the second gas passageway.

In at least one embodiment, the nozzle assembly body is a nozzle cartridge.

In at least one embodiment, the method can include disassembling the spray gun system by removing the nozzle assembly body from the spray gun platform.

Aspects of the present disclosure relate to a spray gun system comprising a spray gun component configured to perform the method above.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a cross-sectional side view of a prior art spray gun in accordance with one embodiment.

FIG. 2 illustrates a cross-sectional side view of a portion of the spray head assembly in FIG. 1 in which selected portions have been removed to illustrate certain features more clearly.

FIG. 3 illustrates a block diagram of a spray gun system with a resilient flow control valve in accordance with one embodiment.

FIG. 4A illustrates a side-view of a spray gun system having spray gun components in accordance with one embodiment.

FIG. 4B illustrates a detailed cross-sectional side view of the spray gun system 400 in accordance with one embodiment.

FIG. 4C illustrates another enhanced cross-sectional side view at an oblique angle of the spray gun system of FIG. 4A and FIG. 4B in accordance with one embodiment.

FIG. 5A illustrates a cross-sectional view of a resilient flow control valve 432 in a closed configuration in accordance with one embodiment.

FIG. 5B illustrates a cross-sectional view of a resilient flow control valve 432 in an open configuration in accordance with one embodiment.

FIG. 6 illustrates a system of FIG. 4A-FIG. 4C being grasped by a hand in accordance with one embodiment.

FIG. 7A illustrates a nozzle assembly with an integrated lid as part of a liquid reservoir system in accordance with one embodiment.

FIG. 7B illustrates a cross-sectional view of a nozzle assembly of FIG. 7A in accordance with one embodiment.

FIG. 8 illustrates an integrated nozzle assembly and liquid reservoir system in accordance with one embodiment.

FIG. 9 illustrates a cross-sectional side view of a nozzle assembly with a downstream baffle in accordance with one embodiment.

FIG. 10 illustrates a cross-sectional side view of a nozzle assembly with an upstream baffle in accordance with one embodiment.

FIG. 11 illustrates perspective view of a nozzle assembly with a liquid reservoir system in accordance with one embodiment.

FIG. 12 illustrates a perspective view of a system in accordance with one embodiment.

FIG. 13A illustrates a perspective view of a nozzle assembly in accordance with one embodiment.

FIG. 13B illustrates a cross-sectional side view of a portion of the nozzle assembly of FIG. 13A in accordance with one embodiment.

FIG. 13C illustrates a cross-sectional side view of a portion of the nozzle assembly of FIG. 13B in accordance with one embodiment.

FIG. 14A illustrates a cross-sectional side view of a portion of a nozzle assembly in accordance with one embodiment.

FIG. 14B illustrates a cross-sectional side view of a portion of the nozzle assembly of FIG. 14A in accordance with one embodiment.

FIG. 15A illustrates a cross-sectional side view of the nozzle assembly and integrated air cap/nozzle in accordance with one embodiment.

FIG. 15B illustrates an enhanced cross-sectional side view of a portion of the nozzle assembly of FIG. 15A in accordance with one embodiment.

FIG. 15C illustrates a perspective rear view of the integrated air cap/nozzle of FIG. 15A and FIG. 15B in accordance with one embodiment.

FIG. 16A illustrates a perspective view of a nozzle assembly in accordance with one embodiment.

FIG. 16B illustrates an exploded view of the nozzle assembly of FIG. 16A in accordance with one embodiment.

FIG. 16C illustrates a cross-sectional bottom view of the nozzle assembly of FIG. 16A in accordance with one embodiment.

FIG. 17A illustrates a perspective view of a lid in accordance with one embodiment.

FIG. 17B illustrates a top elevational view of the lid of FIG. 17A in accordance with one embodiment.

FIG. 17C illustrates a side cross-sectional view of the lid of FIG. 17A and FIG. 17B in accordance with one embodiment.

FIG. 18A illustrates a perspective view of a lid in accordance with one embodiment.

FIG. 18B illustrates a side cross-sectional view of the lid of FIG. 18A in accordance with one embodiment.

FIG. 18C illustrates an enhanced side cross-sectional view of the lid of FIG. 18B in accordance with one embodiment.

FIG. 19A illustrates a perspective view of an integrated lid/nozzle in accordance with one embodiment.

FIG. 19B illustrates a top cross-sectional view of the nozzle of the lid of FIG. 19A in accordance with one embodiment.

FIG. 19C illustrates a side cross-sectional view of the lid of FIG. 19A in accordance with one embodiment.

FIG. 20A illustrates a perspective view of a liquid hose assembly in accordance with one embodiment.

FIG. 20B illustrates a side cross-sectional view of the liquid hose assembly of FIG. 20A in accordance with one embodiment.

### DETAILED DESCRIPTION

The spray equipment of the present disclosure can allow a user to create a spray of atomized liquid for use in a variety of coating applications. Such coating applications can be performed to enhance appearance, impart corrosion protection, impart abrasion resistance, increase moisture resistance, and improve cleanability of substrates.

Aspects of the present disclosure relate to spray equipment that use a resilient flow control valve within a liquid passageway formed therein to control the delivery of a liquid without the use of manually-operated valves such as needle valves actuated by a trigger or actuator. The resilient portion of the resilient flow control valve has the ability to adjust its opening behavior based upon variations in differential pressure, and possesses inherent resiliency to remain in a normally-closed configuration once a pre-determined differential pressure is achieved.

Resilient portions used in the present disclosure are made preferably from materials which are resilient, elastic, and flexible. Such materials are chosen to impart the ability of the valve to regain its initial shape after being deformed in use (i.e., bending, stretching, compression, etc.). These materials can include but are not limited to natural and synthetic rubbers (EPDM, silicone rubber, etc.), thermoplastic polymers (LDPE, polypropylene, etc.), elastomers, thermosetting polymers, and thermoplastic elastomers (including Thermoplastic Vulcanizates, Thermoplastic polyurethanes, Thermoplastic copolyester, Thermoplastic polyamides, etc).

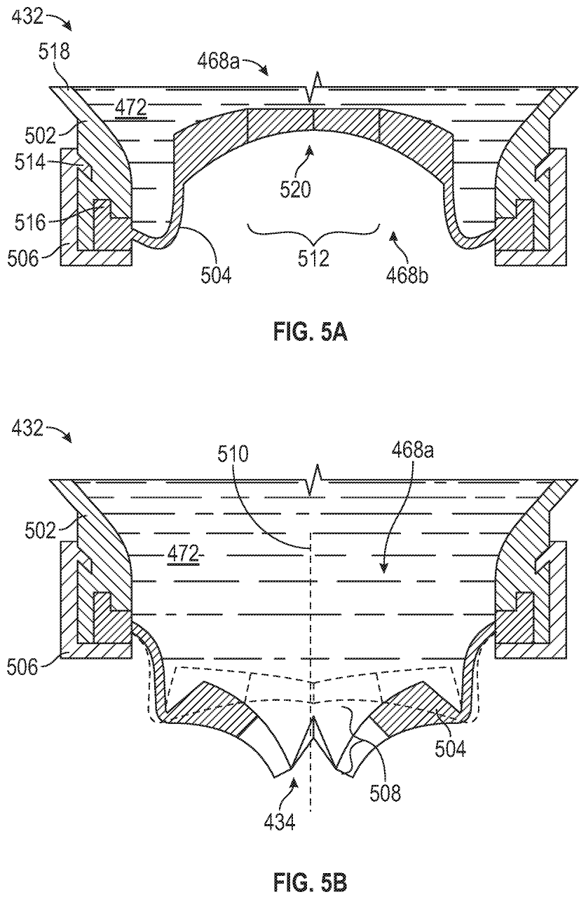

The shape and/or deformation of the resilient portion is affected by the surrounding fluid. As such, it is important to describe how such a process might occur. Resilient portions can be understood to have two “sides” and describe their orientation relative to the fluid flow. The upstream side (e.g. upstream side 468a in FIG. 5A) faces toward a liquid inlet and has a fluid pressure which acts upon it (P1) from the liquid. The downstream side (e.g., downstream side 468b in FIG. 5A) faces the liquid outlet and also has a fluid pressure which acts upon it (P2). These fluid pressures may be independent of any internal or residual stresses designed into the valve itself. It is understood that the valve's shape can be affected by the difference in fluid pressure between its upstream and downstream sides. This gives rise to the concept of differential pressure

$$( Δ P {=}^{def} {P}_{1} - {P}_{2} )$$

across the valve. A positive differential pressure indicates that the average upstream fluid pressure is greater than the average downstream fluid pressure. A negative differential pressure indicates that the average upstream fluid pressure is less than the average downstream pressure.

In a first mode, the resilient portion will have the ability to seal/close in a closed configuration such that liquid does not flow through it. In the first mode, the resilient portion can be configured to remain closed with a closing pressure. The resilient portion may inherently be self-sealing or the seal may be achieved/aided by a prescribed differential pressure.

By adjusting the fluid conditions surrounding the resilient portion, thus changing the differential pressure, the valve may be deformed from its closed configuration (in a first mode of operation of the spray gun system) to an open configuration (e.g., in a second mode of operation of the spray gun system illustrated by FIG. 5B) which allows an opening to overcome the opening pressure and liquid to flow through the valve. The resilient portion can include an attachment structure configured to seal against a component of the resilient flow control valve and/or the nozzle assembly wall.

The spray equipment of the present disclosure may reduce the number of components, complexity, cost, eliminate the need for precision machined needles and seals used in the spray equipment, enable nozzle designs which are more easily removeable from the spray equipment, and enable nozzle designs which keep the paint reservoir sealed from atmosphere even when disconnected from the spray equipment. Such an approach differs in that it does not require a precision machined needle, precision machined valve seat, packing seal, nor needle spring as typically found in spray equipment of the prior art.

Additional aspects of the present disclosure relate to positioning the resilient flow control valve adjacent to the liquid outlet. Such a configuration can further reduce the amount of liquid that is retained by a nozzle assembly and improve cleaning of the nozzle assembly.

Although spray equipment of the present disclosure is designed to address some of the drawbacks associated with current manual, hand-held spray guns, as mentioned above, it should be understood that the concepts disclosed herein could be easily configured for other devices and/or applications that atomize liquid without straying from the scope of the present disclosure.

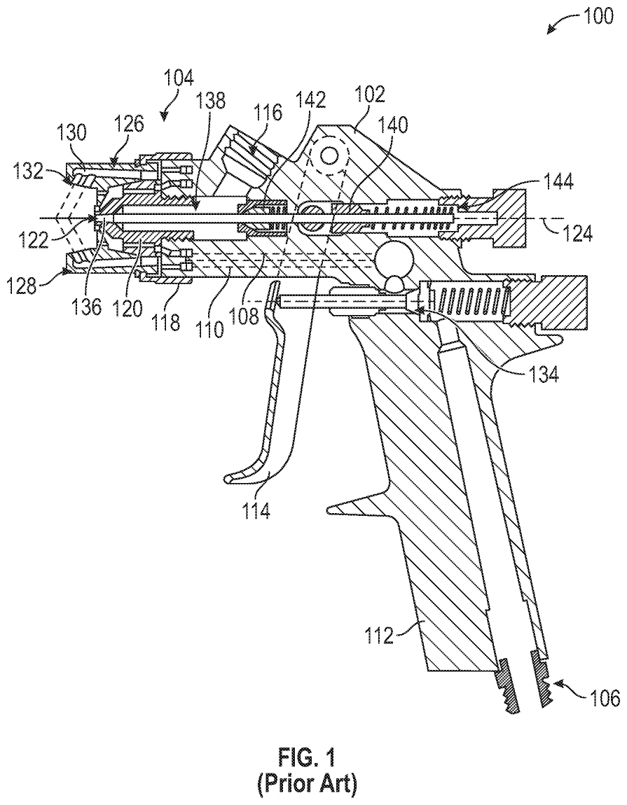

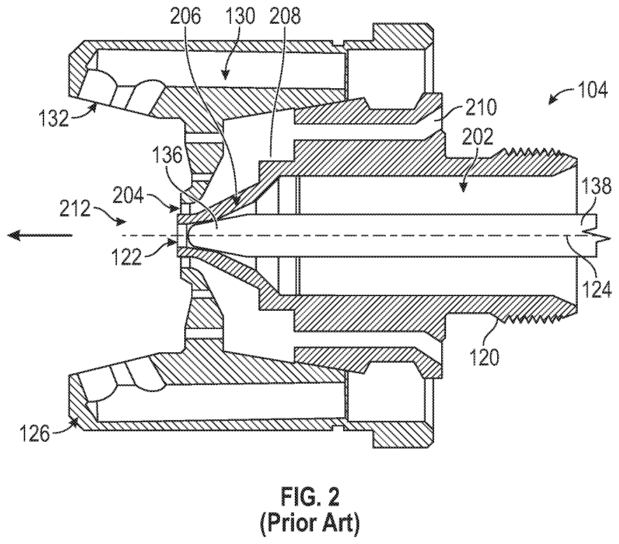

FIG. 1 and FIG. 2 illustrate a spray gun system 100. The spray gun system 100 includes a body 102 and a nozzle assembly 104. The body 102 includes a gas inlet 106 that is configured to couple with a gas source (not shown). The body 102 can also include a grip portion 112, trigger 114, and liquid inlet 116 for connection to a compatible liquid reservoir system(not shown).

The nozzle assembly 104 can include retaining mechanism 118, air cap 126, and nozzle 120. Air cap 126 can include an annular opening 204 and two or more diametrically opposed air horns 128 containing horn passageways 130 which terminate at horn outlets 132. Although air horns 128 and air cap 126 are used to describe this configuration, various other gases and/or carrier fluids besides air may also be used.

The nozzle 120 can include a liquid outlet 122 that is sealed with a needle tip 136 interacting with a needle seat formed in a tapered region 206 of the nozzle wall 208. The nozzle 120 can further include attachment structures for attaching to the body 102 and form a releasable connection.

To operate the spray gun system 100, a user's hand depresses the trigger 114 which actuates valve 134 and causes needle valve 138 to retreat (via needle boss 140 and biasing mechanism engagement structure 144) along spray axis 124 away from the nozzle 120. The actuation of valve 134 allows gas to flow from the gas inlet 106, through valve 134, and into a shaping gas passageway 110, and an atomizing gas passageway 108.

The atomizing gas passageway 108 and shaping gas passageway 110 can be fluidically coupled with an atomizing gas passageway 210 and a horn passageway 130 respectively. Gas from the atomizing gas passageway 210 can flow along the exterior of nozzle wall 208 and through annular opening 204 (i.e., forming a gas outlet) creating a venturi effect which pulls liquid from a liquid reservoir system through the liquid inlet 116 and liquid passageway 202 until the liquid exits the nozzle 120 at liquid outlet 122 where the gas atomizes the liquid at mixing zone 212. In some embodiments, the liquid reservoir system can benefit from gravity and/or pressure assistance. For example, the liquid reservoir system can be pressure assisted which can allow handling of viscous liquids.

The mixing zone 212 is where a stream of gas from the atomizing gas passageway 210 exiting the annular opening 204 merges, interacts with, intersects, and/or atomizes a stream of liquid from the liquid passageway 202 exiting the liquid outlet 122. Gas can exit the horn passageway 130 at horn outlet 132 to shape the atomized liquid creating an approximately elliptical spray pattern.

When the trigger 114 is released, a biasing mechanism (such as a spring) can bias the needle valve 138 to a closed position, which shuts off the flow of liquid. The needle valve 138 can also mate with a packing seal 142 to create a fluid-tight seal between the body 102 and liquid passageway 202. Over time, the packing seal 142 may wear, and as such, can be replaced.

In at least one embodiment, the spray gun system 100 can include a body 102 that has both the liquid passageway 202 and atomizing gas passageway 210 formed therein. Thus, to clean the spray gun system 100, the air cap 126 and the nozzle 120 are removed.

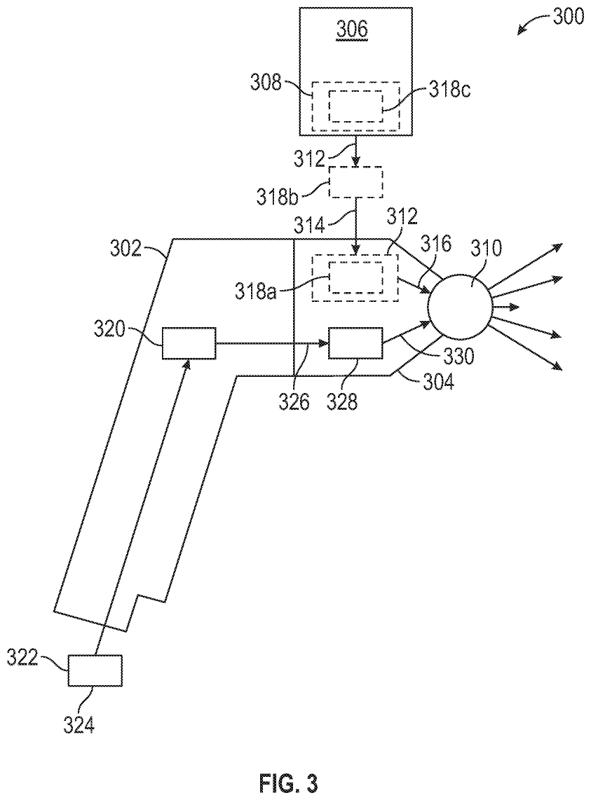

FIG. 3 illustrates a functional block diagram of a spray gun system 300 according to an aspect of the present disclosure. The spray gun system 300 can include a spray gun platform 302, a nozzle assembly 304, a liquid reservoir system 306 having a liquid reservoir outlet 308 and containing a liquid, and a gas source 324 having a gas 322. The liquid reservoir system 306 can include any suitable container, reservoir or housing that can be directly or indirectly (e.g., via a conduit, hose, aerosol can, etc.) attached to the liquid inlet 314 of the nozzle assembly 304. In at least one embodiment, the liquid inlet 314 refers to a functional inlet that is mateable with the liquid reservoir outlet 308 and can be located inside of a body of the nozzle assembly 304. In at least one embodiment, the spray gun platform 302, nozzle assembly 304 and liquid reservoir system 306 (including liquid reservoir components thereof) can be referred to as spray gun components. The nozzle assembly 304 and liquid reservoir system 306 can further be configured to attach to the spray gun platform 302.

The liquid reservoir system 306 containing liquid reservoir outlet 308 may be reusable or disposable and can come prefilled with a liquid or be fillable on site. The liquid reservoir system 306 may optionally have a removeable lid portion to aid in the opening and closing of the container. In at least one embodiment, the liquid reservoir system 306 can include a liquid reservoir component such as a gravity-fed liquid reservoir system including a lid, adaptor, or portions thereof. In at least one embodiment, the liquid reservoir outlet 308 can flow into a liquid inlet 314 and out of the liquid outlet 316 in the spray gun system 300. The liquid inlet 314 and liquid outlet 316 can be formed from openings in various components of the spray gun system 300. The liquid inlet 314 and liquid outlet 316 can be connected via the liquid passageway 312.

The gas source 324 may be fluidly isolated from the atmosphere (i.e., closed vessel), or contain a fluid inlet to allow the intake of gas 322 from the surroundings (i.e., air compressor). In at least one embodiment, gas 322 from the gas source 324 can flow into nozzle gas inlet 326 and out of the spray gun system 300 via the gas outlet 330. The nozzle gas inlet 326 and gas outlet 330 can be connected via the gas passageway 328.

In some embodiments, at least one of the gas sources 324 and liquid reservoir system 306 is pressurized. In some embodiments, the gas source 324 is pressurized. In some embodiments, the liquid reservoir system 306 is not pressurized. In other embodiments, the liquid reservoir system 306 is not pressurized by means other than hydrostatic pressure (e.g., the liquid reservoir system 306 is positioned vertically above the nozzle assembly 304 in a gravity-fed configuration).

In at least one embodiment, the spray gun system 300 can have a liquid reservoir system 306 which is fluidly connected to a resilient flow control valve 318a. As depicted in FIG. 3, the resilient flow control valve may be positioned at a variety of locations (e.g., 318a, 318b, 318c all refer to potential locations of the resilient flow control valve) along the liquid flow path from the liquid reservoir system 306 to the mixing zone 310. The term resilient flow control valve 318a can be used interchangeably with resilient flow control valve 318b and resilient flow control valve 318c.

In at least one embodiment, the resilient flow control valve 318a can be placed such that an adequate pressure differential (e.g., sufficient to change the resilient flow control valve 318a to an open configuration) can be created and controlled at that location during operation of the spray gun system 300. In at least one embodiment, a resilient flow control valve 318a is located within the liquid passageway 312 of the nozzle assembly 304. The location of the resilient flow control valve 318a within the liquid passageway 312 can be dependent upon several factors including the size and shape of both the valve and passage, the desirability to have expansion chambers within the liquid passageway, and any considerations around residual liquid present within the liquid passage upon closing of the resilient flow control valve 318a. In at least one embodiment, the resilient flow control valve 318a could be placed in the middle of the liquid passageway 312. In at least one embodiment, the resilient flow control valve 318a is located at the liquid outlet of the liquid passageway 312 such that the outlet of the resilient flow control valve 318a is adjacent the mixing zone 310.

In another embodiment, a resilient flow control valve 318c is located within the liquid reservoir system 306, for example, in a liquid reservoir outlet 308 or lid of a liquid reservoir system 306. In at least one embodiment, the resilient flow control valve 318b can be located within a conduit connecting the liquid reservoir system 306 to the nozzle assembly 304. From the examples given, it should be understood that multiple locations are acceptable for the placement of the resilient flow control valve.

In at least one embodiment, two or more resilient flow control valves may be used within the same spray gun system 300. The use of more than one resilient flow control valve may provide a back-up in the event that another resilient flow control valve fails. Additionally, the use of two or more resilient flow control valve may allow separable components to remain sealed to air when disconnected. In at least one embodiment, resilient flow control valve 318a is located at a liquid inlet 314 to nozzle assembly 304 while another resilient flow control valve 318c is located within a lid of a liquid reservoir system. When the liquid reservoir system is disconnected from the nozzle assembly, both components can remain sealed to the atmosphere.

The spray gun system 300 may include a gas valve 320 placed between the gas source 324 and the nozzle gas passageway 328 to manage the flow of gas within the spray gun system 300.

Exemplary gas valves 320 include poppet, ball, pinch, diaphragm, and needle-style valves commonly used in pneumatic applications. In at least one embodiment, the gas valve 320 can be placed within the spray gun system 300 such that it (indirectly) affects a degree of openness of at least one resilient flow control valve 318a. An indirect fluid communication path may extend across dissimilar passages (i.e., nozzle gas passageway 328 to mixing zone 310 to liquid passageway 312, across dissimilar fluids (i.e., pressure transmitted between gas and liquid), or also across a (deformable) partition separating passages.

The operation of the spray gun system 300 of the present application can be described through a sequence of events. In a first state, the spray gun system 300 can contain a liquid within the liquid reservoir system 306, and a gas within the gas source 324. In this state, both the gas valve 320 and the resilient flow control valve 318a are in a closed position. Due to both valves being closed, there is not flow of either gas or liquid through the spray gun system 300.

In a first mode, the gas valve 320 can be opened which causes gas to flow from the gas source 324 through the gas valve 320. Via the previously described fluid coupling mechanism, the flow of gas in the system alters the differential pressure across the resilient flow control valve 318a. In a first mode, even though gas is flowing, the differential pressure may not be enough to change the resilient flow control valve 318a from the closed configuration. In a second mode, under certain gas flow conditions, a pre-defined opening differential pressure of the resilient flow control valve 318a may be reached, thus causing the resilient flow control valve 318a to change to an open configuration, enabling liquid to pass through the liquid passageway 312 (if the optional liquid is present). With both gas and liquid passing through their respective passages, the two fluids are routed to the mixing zone 310.

Within the mixing zone 310, the atomization and spray formation processes can take place in the second state. The atomization and spray formation processes can result in the creation of a spray including a mixture of at least the two fluids (gas 322 and liquid) wherein the liquid has been atomized into small droplets from its initial bulk fluid state.

When it is desired to reduce or stop the spray emanating from the spray gun system 300, the gas valve 320 may be either partially or fully closed. By closing the gas valve 320 (e.g., by a user interacting with an actuator), the flow of gas through the spray gun system 300 can be stopped, and in turn, the differential pressure across the resilient flow control valve 318a can be reduced. When the prescribed closing differential pressure of the resilient flow control valve 318a is reached, the resilient flow control valve 318a can seal itself and stop the flow of liquid through the liquid passageway 312. This closing process returns the spray gun system 300 to the first state.

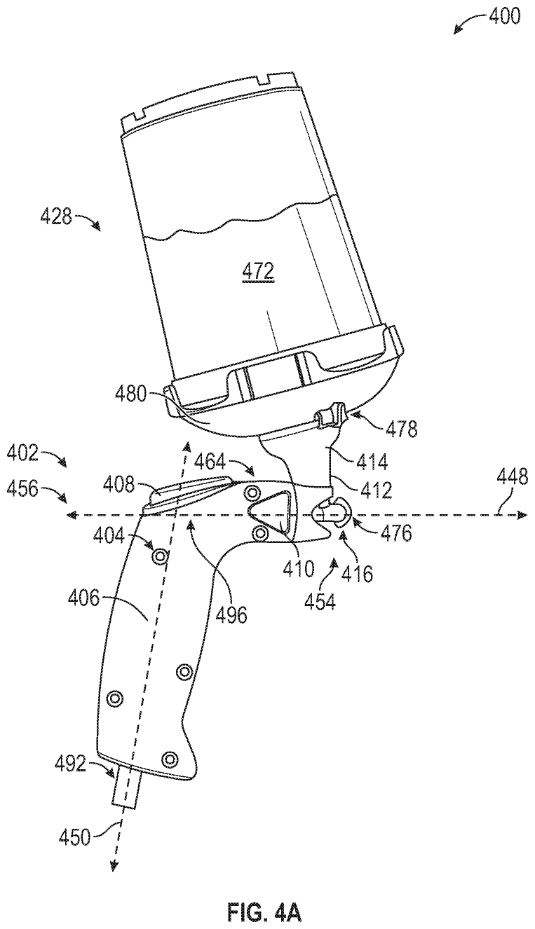

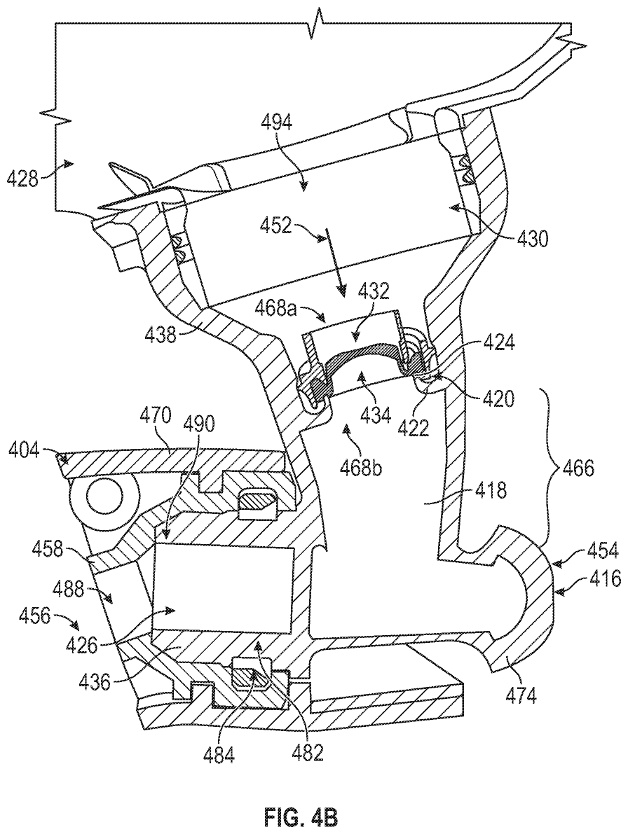

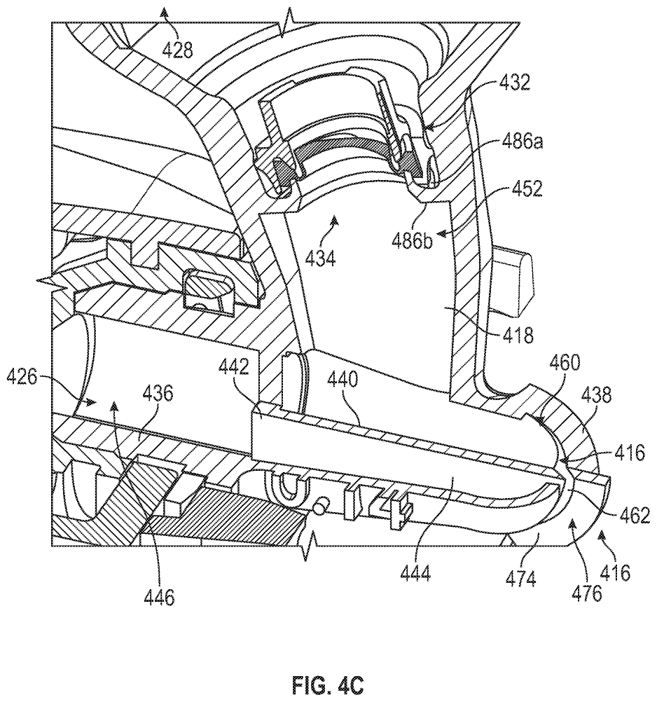

FIG. 4A, FIG. 4B, and FIG. 4C depict a spray gun system 400. In at least one embodiment, the spray gun system 400 can be similar to a spray gun system 100. The spray gun system 400 can include a spray gun platform 402, a nozzle assembly 412, and a liquid reservoir system 428. Each of the aforementioned spray gun components can be releasably attached to each other. In at least one embodiment, at least some of the components of 400 can be integrally formed.

Aspects of the present disclosure may also relate to an integrated system. For example, a pouch (i.e., liquid reservoir system) with a liquid 472 contained therein can have the nozzle assembly fixedly bonded to the pouch.

Although a gas and a liquid are referred to throughout the specification, aspects of the present disclosure may also relate to a plurality of fluids. For example, a third fluid can be introduced into the liquid chamber of the nozzle assembly 412 to act as a catalyst.

In at least one embodiment, the spray gun platform 402 can include a spray gun body 404 that can be formed from various polymeric, metal, or ceramic materials. Various internal gas passageways can be formed within the spray gun body 404 that connect the gas source to the gas outlet 488. The spray gun body 404 can include a grip portion 406 for handheld gripping on the spray gun platform 402. As shown, the spray gun platform 402 can include a pistol-style grip.

The spray gun platform 402 can include a grip axis 450 and longitudinal axis 448. The grip axis 450 can be formed from the grip portion 406.

The longitudinal axis 448 of the spray gun system 400 can be formed by the direction of spray for the liquid. For example, the spray gun platform 402 can have a first end 454 defined by the liquid outlet and a second end 456 defined by the nozzle gas inlet 490 and/or gas passageway 426. In at least one embodiment, the longitudinal axis 448 can extend from the liquid outlet 416 to the second end 456. The longitudinal axis 448 can also be defined by a portion of the gas passageway, liquid passageway, or combinations thereof.

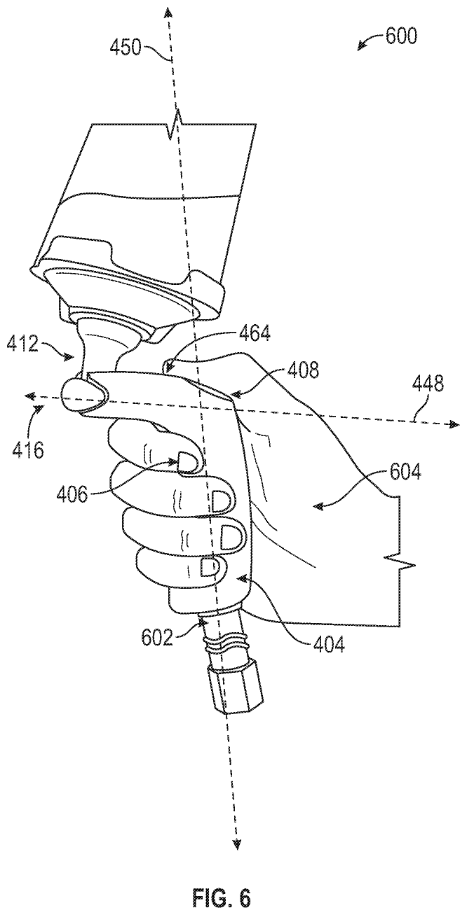

In at least one embodiment, a longitudinal plane can be formed from both the longitudinal axis 448 and grip axis 450. A transverse plane can be orthogonal to the longitudinal plane. Both the longitudinal plane and transverse plane can intersect the longitudinal axis. In at least one embodiment, the longitudinal axis 448 and grip axis 450 can form an angle 496 of at least 90 degrees. The angle 496 is measured from the point where a user's index finger would grasp the grip axis (as shown in FIG. 6).

In at least one embodiment, portions of the liquid reservoir system 428, the liquid passageway 452, and liquid outlet 416 can intersect the longitudinal plane. In one embodiment, the spray gun platform 402 comprises a grip portion 406 and an actuator 408 which is generally accessible via one or more of the user's fingers or thumb while holding the grip portion 406 and, upon actuation of the actuator 408, opens a gas valve (not shown) to allow a gas to flow along gas passageways within spray gun platform 402. In at least one embodiment, the actuator 408 can be positioned upon a top surface 464 of the spray gun platform 402 such that it is operable by a thumb of the user as shown in FIG. 6.

The spray gun body 404 can also include a nozzle retention mechanism 484 that is mechanically coupled to the nozzle release mechanism 410. The nozzle retention mechanism 484 can be configured to engage with the retention structure 482 (shown as an annular recessed ring formed in the tubular wall 436) of the nozzle assembly 412. The nozzle release mechanism 410 can be configured to release the nozzle assembly 412 when the nozzle release mechanism 410 is activated. For example, the spray gun body 404 can have an exterior housing 470 and an interior tubular wall 458. In at least one embodiment, the tubular wall 458 can form a chamber 446 in the gas passageway 426 for the spray gun body 404. The tubular wall 458 can also have a retention structure 420 formed or assembled therein. In at least one embodiment, the nozzle assembly 412 and the liquid reservoir system 428 can be removed from the spray gun body 404 as a single unit.

The nozzle assembly 412 can have a nozzle assembly body 414 and a resilient flow control valve 432.

In at least one embodiment, the nozzle assembly body 414 is configured to mate with the spray gun body 404. In at least one embodiment, the nozzle assembly body 414 can be integrally molded from a single piece. In other embodiments, one or more components are combined to create the nozzle assembly body 414. The nozzle assembly body 414 can have a retention structure 482 configured to mate with the nozzle retention mechanism 484. For example, tubular wall 436 can have a retention structure 482 in the form of a depression which engages with a spray gun body 404 in a push-fit connection. The nozzle retention mechanism 484 can be mechanically coupled to the nozzle release mechanism 410 which is shown as a depressible button. In at least one embodiment, the nozzle release mechanism 410 actuates along a plane that is transverse to the direction of spray. In some embodiments, a compliant seal is included as part of either tubular wall 458 or tubular wall 436 to create a fluid-tight seal between tubular wall 458 and tubular wall 436.

In at least one embodiment, the gas passageway 426 can be formed from internal fluid passageways of the nozzle assembly body 414 and/or spray gun body 404. For example, the gas passageway 426 can be formed from the tubular wall 458, and the tubular wall 436. The gas passageway 426 of the nozzle assembly 412 can be formed between a nozzle gas inlet 490 (which is configured to receive gas from a gas outlet 488 of the spray gun platform 402 which is received from the gas source 492) and terminate at a gas outlet 462 formed from the tubular wall 436. The gas outlet 462 can have a smaller cross-sectional area than the through-hole area formed by the tubular wall 436 (measured orthogonal to the longitudinal axis 448).

The gas can flow via gas passageway 426, through nozzle gas inlet 490, past ledge 442, and out through gas outlet 462 formed from the tubular wall 436 and/or partition wall 440 and out past the shelf 474 into the mixing zone 476. In at least one embodiment, the nozzle assembly 412 can be an external mix nozzle with mixing zone 476 adjacent to the shelf 474. Aspects of the present disclosure can relate to internal mix nozzles where the gas and liquid interact within one of the passageways. An internal mix nozzle includes a stand-off distance between the gas outlet 462 and the liquid outlet 416. For example, the liquid outlet 416 can be further upstream of the gas outlet 462 in an internal mix nozzle.

In at least one embodiment, the ledge 442 within the gas passageway 426 can function to provide turbulent flow and improve the spraying performance of spray gun platform 402. In at least one embodiment, the ledge 442 is optional and the gas passageway 426 can be a featureless surface that does not include the ledge 442.

The gas chamber 444 can be formed from an interior partition wall 440 (which can separate the gas chamber 444 from the downstream liquid chamber 418) and/or tubular wall 436 (which can separate gas chamber 444 from outside of the nozzle assembly 412). In at least one embodiment, the partition wall 440 can be considered a portion of the tubular wall 436 that defines the gas passageway 426 and/or a portion of the liquid passageway 452.

The spray gun system 400 can include a liquid reservoir system 428 configured to hold the liquid 472. As shown, the liquid reservoir system 428 can be configured to detachably couple with the nozzle assembly 412 via a connection format 478 on a lid 480. The connection between the nozzle assembly 412 and liquid reservoir system 428 can be fluid-tight.

FIG. 4A illustrates an exemplary liquid reservoir system 428 connected to the nozzle assembly 412 via a connection format 478. Both the liquid reservoir system 428 and nozzle assembly 412 can have their own connection format. For example, the nozzle assembly 412 can have a first connection format at one end and the lid 480 of the liquid reservoir system 428 can have a second connection format. Examples of connection formats 478 and liquid reservoir systems 428 can be found commercially under the trade designation PPS by 3M (Saint Paul, MN). Although a gravity-fed liquid reservoir system 428 is shown, pressure-fed liquid reservoir systems 428 are also possible. Examples of possible connection formats 478 can include a twist lock, threaded, push fit, snap fit connection, or combinations thereof.

In at least one embodiment, the liquid 472 in liquid reservoir system 428 can be fluidly connected to a liquid passageway 452 in nozzle assembly 412. The liquid 472 contained in the liquid reservoir system 428 can flow into a liquid passageway 452 (e.g., by gravity-fed or by pressure-fed operation). In at least one embodiment, the liquid passageway 452 in the nozzle assembly 412 is formed between the liquid inlet 494 of the nozzle assembly 412 (formed from the opening formed by the tubular wall 438 and the liquid outlet 416. The liquid passageway 452 can include (1) a liquid chamber 430 (e.g., forming a portion of the liquid passageway 452) that holds the liquid when the liquid exits the liquid reservoir system 428 and (2) the downstream liquid chamber 418.

The liquid chamber 430 can lead to the resilient flow control valve 432. Thus, an upstream side 468a of the resilient flow control valve 432 can be in contact with the liquid 472 and/or fluidically coupled to the liquid inlet 494 and the downstream side 468b can be in contact with the atmosphere and fluidically coupled with the liquid outlet 416.

The resilient flow control valve 432 is described in more detail in FIG. 5A and FIG. 5B.

The nozzle assembly 412 can include a retention structure 420 disposed in the liquid passageway 452. In at least one embodiment, the retention structure 420 can include a flange, lip, shelf, ledge, or detent. In at least one embodiment, the retention structure 420 can be capable of being push-fit with the resilient flow control valve 432. The retention structure 420 can protrude radially and/or inwardly from the sidewall of the liquid passageway 452. As shown, the retention structure 420 can comprise a flange 422 and a rim 424 distal to the flange 422. The retention structure 420 can have an upstream side 486a and downstream side 486b.

In at least one embodiment, the rim 424 can be annular and have a narrower diameter than the diameter of the liquid passageway 452. The rim 424 can form an opening within the nozzle assembly 412 that opens into the downstream liquid chamber 418 or at least separates the liquid passageway 452 into two sections. In at least one embodiment, the resilient flow control valve 432 can be positioned adjacent to the rim 424 and potentially supported by the flange 422. Thus, the resilient flow control valve 432 can be disposed within the liquid passageway 452. In at least one embodiment, the downstream side 468b of the resilient flow control valve 432 can contact the upstream side of the flange 422.

When the resilient flow control valve 432 is placed in the nozzle assembly 412, the resilient flow control valve 432 can form a fluid-tight seal within the liquid passageway 452 and/or between the liquid chamber 430 and the downstream liquid chamber 418. In at least one embodiment, the resilient flow control valve 432 can also form a fluid-tight seal with the retention structure 420 such that the available path for a liquid 472 is through the resilient flow control valve 432 and not through any gap between tubular wall 438 and the resilient flow control valve 432.

In at least one embodiment, the resilient flow control valve 432 can be further secured to the retention structure 420 using adhesives, ultrasonic welding, overmolding, rotational welding, or other attachment mechanisms. In at least one embodiment, an edge (e.g., downstream side 468b) of the resilient flow control valve 432 and/or the complementary retention structure 420 (e.g., on the upstream side) can have adhesive disposed therein to facilitate bonding the two components.

In at least one embodiment, the downstream liquid chamber 418 can be optional. For example, the resilient flow control valve 432 can abut the liquid outlet 416 or form the liquid outlet 416. For example, an outer diameter of the resilient flow control valve 432 can abut the tubular wall 438. In at least one embodiment, the downstream liquid chamber 418 can have a dimension 466 measured from a center of the opening 434 to any portion of liquid outlet 416 (along the liquid passageway) that is no greater than 2 times the dimension of the resilient flow control valve 432 (e.g., the largest diameter measurement of the frame structure 506 as shown in FIG. 5A).

The tubular wall 438 can have a tapered region 460 leading to and forming the liquid outlet 416 therein. In at least one embodiment, the liquid outlet 416 is formed from a distal end of the tubular wall 438 and the partition wall 440. In at least one embodiment, the downstream liquid chamber 418 can include different chamber sections that are oriented orthogonally to the longitudinal axis 448 thereby forming an L-shape. In at least one embodiment, liquid passageway 452 is approximately linear. In at least one other embodiment, liquid passageway 452 forms a plurality of curves.

The resilient flow control valve 432 can be configured such that in a first mode of the spray gun system 400, differential pressure across the resilient flow control valve 432 can be less than an opening pressure of the resilient flow control valve 432 and results in a closed configuration of the resilient flow control valve 432. Thus, an insubstantial pressure differential is created at the downstream side 468b, and no liquid is dispensed. The resilient flow control valve 432 can be configured such that in a second mode, a substantial flow of gas can exit from gas outlet 462 which creates a differential pressure that is at least the opening pressure of the resilient flow control valve 432.

In response to the differential pressure being at least the opening pressure of the resilient flow control valve 432, the resilient flow control valve 432 can thereby change to an open configuration thereby forming the opening 434. The opening 434 of resilient flow control valve 432 allows liquid to flow from the gas passageways 426, through opening 434, into a chamber (e.g., downstream liquid chamber 418) or directly into a mixing zone 476 (adjacent to the shelf 474 and/or liquid outlet 416), where the gas can atomize the liquid at the mixing zone 476.

A resilient flow control valve 432 may be positioned at variety of locations along the liquid flow path (e.g., liquid passageway 452) as discussed herein such that an adequate pressure differential can be created and controlled at that location. In at least one embodiment, a resilient flow control valve 432 is located in the middle of the nozzle as shown in FIG. 4B.

FIG. 5A and FIG. 5B illustrate a cross-sectional view of the resilient flow control valve 432. FIG. 5A illustrates the resilient flow control valve 432 in a first mode, and FIG. 5B illustrates the resilient flow control valve 432 in a second mode.

The resilient flow control valve 432 is known in the art and referred to in many ways including resilient valves, resilient closure members, discharge valve members, deformable outlet valves, dispensing closures, valve-controlled dispensing closures, elastomeric valves, cross-slit valves, and duckbill valves (not all encompassing). Examples of such valves can include but are not limited to EP 3,280,652B1 , U.S. Pat. Nos. 5,839,1112, 1,739,871, 5,676,289, and 6,053,194. Applications of such valves include food and beverage containers, powder, lotion, and soap dispensers, and hand-pump spray bottles to name a few.

In at least one embodiment, the resilient flow control valve 432 comprises at least a resilient portion 504 and optionally a frame structure 506 and/or a support portion 502. The components of the resilient flow control valve 432 can be formed from separate and distinct materials, each with their own properties.

The frame structure 506 can have a structure that is configured to mate with the retention structure of the nozzle assembly. The frame structure 506 can be relatively more rigid than the resilient portion 504 (e.g., as measured using a shore A hardness test method). For example, the frame structure 506 can be rigid, while the resilient portion 504 is elastomeric. The frame structure 506 can be configured to bond with both the resilient portion 504 and the support portion 502. The frame structure 506 can include various attachment features to facilitate mechanical engagement with the nozzle assembly or other components of the resilient flow control valve 432. For example, the frame structure 506 can include a barb 514 to secure the resilient portion 504 via the support portion 502.

In at least one embodiment, the frame structure 506 can be annular such that each portion of the frame structure 506 is equidistant from the center of the opening 434. By having a frame structure 506, an edge of the resilient portion 504 can be anchored within the liquid passageway 452 and the position of the resilient portion 504 can be maintained throughout any differential pressure. Further, by having the frame structure 506 separate from the resilient portion 504, the nozzle assembly can be customizable depending on the application by replacing the resilient flow control valves 432.

In at least one embodiment, the support portion 502 can be a component that acts as an intermediary between the resilient portion 504 and the frame structure 506. As shown in FIG. 5A, the support portion 502 is also configured to direct a liquid toward the resilient portion 504.

In at least one embodiment, the support portion 502 can be formed from a more rigid material than the resilient portion 504. In at least one embodiment, the support portion 502 can be configured to promote bonding of the resilient portion 504 to the frame structure 506 and/or dissipate force from the resilient portion 504. The support portion 502 can have features that aid in the retention and/or force dissipation of the resilient portion 504 with respect to the frame structure 506. For example, the support portion 502 can include a complementary feature configured to mate with barb 514 on the frame structure and another complementary feature configured to mate with attachment structure 516 on the resilient portion 504. In at least one embodiment, the support portion 502 or the frame structure 506 can have a rim 518 on the distal surface opposite from the opening 434 direction. In at least one embodiment, the rim 518 can have an outer radial diameter (e.g., measured in a plane orthogonal to the resilient flow control valve axis 510) that is greater than the outer radial diameter of the frame structure 506.

Resilient portions may be designed with a pre-defined opening differential pressure (e.g., opening pressure) which signifies when the valve deformation transitions from the first mode to the second mode. The degree of openness, or variation in the resilient portion's open cross-sectional area, may be further controlled by the magnitude of the differential pressure. This provides for a degree of flow regulation in that there are many possible deformable states of the resilient flow control valve between a closed configuration and an open configuration. Another important feature of the resilient portion is that it may be returned to the first mode upon removal of the differential pressure stimulus. A closing differential pressure may be designed into or characteristic of the valve which describes when the valve will transition from a second mode back to a first mode. In at least one embodiment, aspects of the resilient portion can dispense liquid in response to a negative differential pressure across the resilient portion 504.

The resilient portion 504 can have a self-sealing opening 434 formed from one or more slits 520 therein. When in a closed configuration, the one or more slits 520 can be touching each other and forming a fluid-tight seal. The one or more slits 520 can be a feature that permits an opening 434 to form in the resilient portion 504 when the resilient portion 504 is in the open configuration and in response to an opening pressure. In at least one embodiment, the one or more slits 520 can be horizontal, vertical, a combination, or even cross and star patterns. The one or more slits 520 can have a first slit dimension 512 which can be designed such that the intended liquid 472 will dispense from opening 434 when a target pressure differential is achieved from upstream side 468a to downstream side 468b. The first slit dimension 512 can further control the flow rate of the liquid 472.

As shown on FIG. 5B, when in the open configuration, the opening 434 can open outwardly along a resilient flow control valve axis 510 (towards the direction of liquid 472 flow. The liquid flow rate of the resilient portion 504 can be controlled based on the open area formed by the one or more slits 520. The open area can be partly defined by second slit dimension 508 and first slit dimension 512. In at least one embodiment, the second slit dimension 508 is defined along the resilient flow control valve axis 510 and the second slit dimension 508 is defined in a plane orthogonal to the resilient flow control valve axis 510.

FIG. 6 illustrates a system 600 that includes the components of spray gun system 400 and a gas source 602 coupled to the spray gun system 400. The system 600 also includes a hand 604 of a user. The system 600 illustrates that the actuator 408 is positioned on or proximate to the top surface 464 of the spray gun body 404. The actuator 408 can be configured to be positioned such that the hand 604 can use the thumb to depress the actuator 408 while the hand 604 is gripping the grip portion of the spray gun body 404. As shown, the grip axis 450 passes thru the actuator 408. The longitudinal axis 448 can pass through the nozzle assembly 412 and liquid outlet 416.

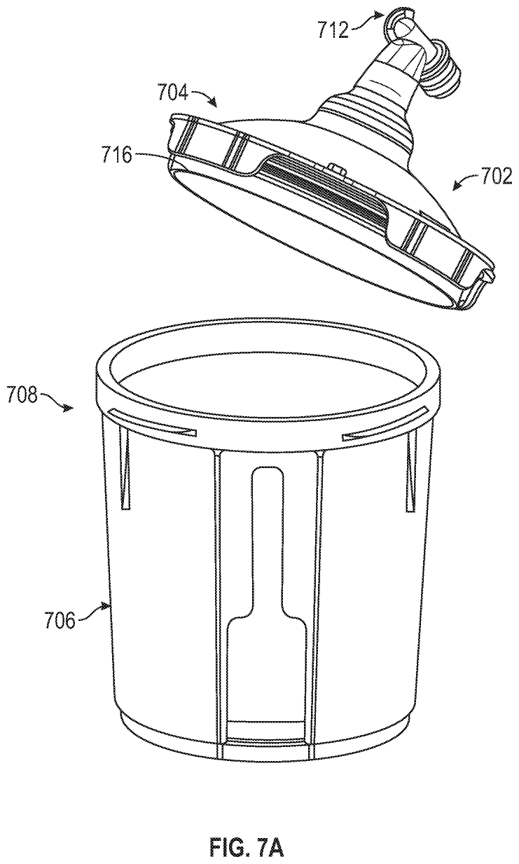

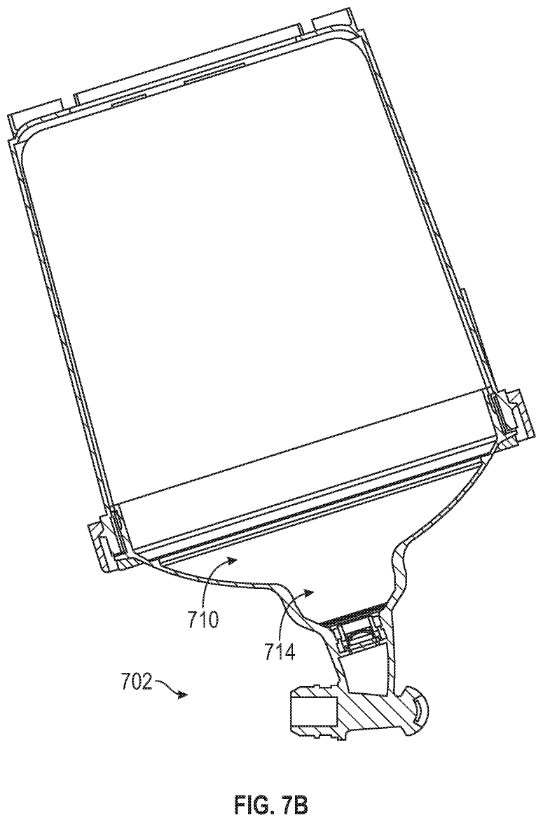

FIG. 7A and FIG. 7B illustrate an integrated lid/nozzle 702 that is configured similar to nozzle assembly 412 except that integrated lid/nozzle 702 includes an integrally formed lid portion 704 without a connection format between a lid and nozzle assembly. The lid portion 704 can be releasably mateable with a cup 706 as shown in FIG. 4A.

In at least one embodiment, the rim 716 of the lid portion 704 can form a liquid inlet 714 which together with liquid outlet 712 defines the liquid passageway 710.

In at least one embodiment, a liquid reservoir system 708 can be formed with a combination of the cup 706 and the lid portion 704.

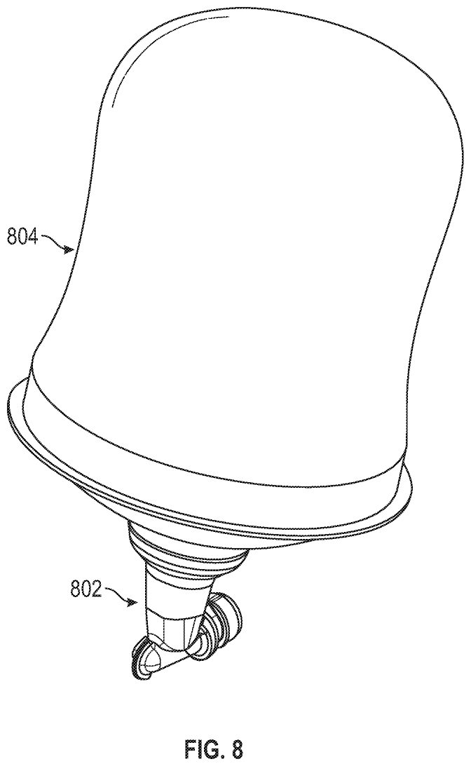

FIG. 8 illustrates a nozzle assembly 802 that is configured similar to integrated lid/nozzle 702 except that the nozzle assembly 802 is integrated into the liquid reservoir system 804 without a connection format between a lid and a cup. The nozzle assembly 802 and liquid reservoir system 804 can be shipped with the liquid inside of the liquid reservoir system 804 and thrown away or stored after a single use. Thus, liquid reservoir system 804 can be sealed to nozzle assembly 802. In this configuration, the liquid can be sealed from the atmosphere in a first state, even when the embodiment is detached from the spray gun (not shown).

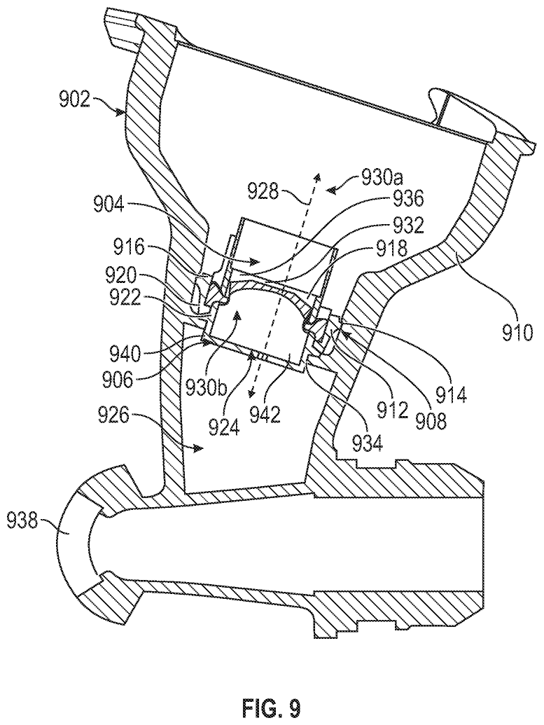

FIG. 9 illustrates a nozzle assembly 902 that is configured similar to nozzle assembly 412 except that nozzle assembly 902 includes resilient flow control valve 904 with a baffle 906 mounted downstream of the resilient portion 918. Further, in nozzle assembly 902, the shelf 938 can be oriented along a longitudinal plane as described in FIG. 4A.

The nozzle assembly 902 can include a tubular wall 910 forming a liquid passageway as described with respect to nozzle assembly 412. The tubular wall 910 can include retention structure 914 and retention structure 920. Both retention structure 914 and retention structure 920 can be annular and can include various protrusions, shelves, divots, or depressions to aid in retaining the resilient flow control valve 904. The retention structure 920 and retention structure 914 can separate the liquid passageway and form a downstream liquid chamber 926.

The resilient flow control valve 904 can be similar to resilient flow control valve 432 in FIG. 5A. The resilient flow control valve 904 can have an upstream side 930a oriented toward a liquid reservoir system(not shown) and a downstream side 930b oriented toward the direction of spray. The resilient flow control valve 904 can be oriented along resilient flow control valve axis 928.

The resilient flow control valve 904 can have a resilient portion 918, an attachment structure 912 (similar to attachment structure 516 in FIG. 5A), and a frame structure 908. The frame structure 908 can include a barb 916 that is configured to mate and form a snap-fit with retention structure 914.

The baffle 906 can help regulate the liquid being dispensed by the resilient flow control valve 904. In at least one embodiment, the baffle 906 can be considered part of the resilient flow control valve 904. The baffle 906 can also be a separate part which is mateable with the nozzle assembly 902. The baffle 906 can include a wall 942 with an opening 924 formed therein. In at least one embodiment, the dimension of the opening 924 is less than the dimension established by a rim of the retention structure 920. For example, the diameter of the opening 924 can be no greater than one-half the diameter of the retention structure 920. The baffle 906 can also include a tubular wall 940 attached or formed with wall 942.

In at least one embodiment, the downstream side 930b of the resilient flow control valve 904 can mate with an upstream side of the baffle 906. The baffle 906 can include a feature such as barb 922 on the tubular wall 940 to mate with the retention structure 920 and include additional features to allow fitment with the frame structure 908. In at least one embodiment, the baffle 906 can fit downstream over the resilient flow control valve 904. For example, the inner diameter 934 of the baffle 906 can be greater than the inner diameter 936 of the resilient flow control valve 904 (adjacent to the resilient portion 918).

As shown, liquid can pass from the upstream side 930a to the downstream side 930b through resilient portion 918. The dispensed liquid can pass through opening 924 and into downstream liquid chamber 926. In at least one embodiment, an opening 932 of the resilient portion 918 can be axially aligned or even coaxial with opening 924 along the resilient flow control valve axis 928.

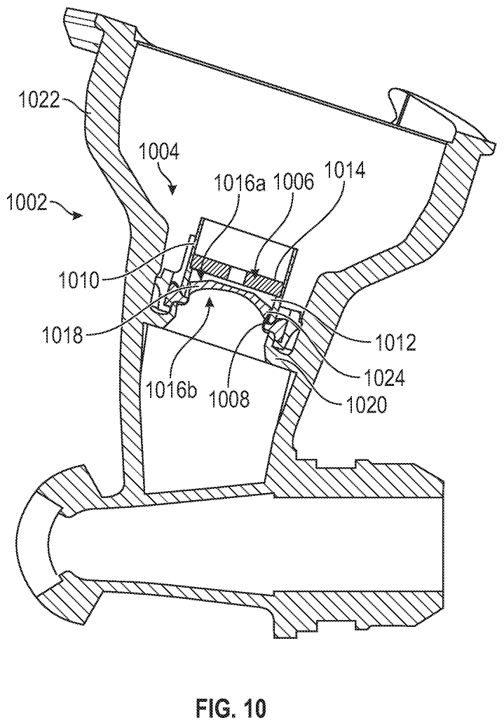

FIG. 10 illustrates a nozzle assembly 1002 similar to nozzle assembly 412 except that the resilient flow control valve 1004 is modified to include a baffle 1006. For example, nozzle assembly 1002 can include a wall 1022 having a flange 1020. The downstream side 1016b of the resilient flow control valve 1004 can be disposed on the flange 1020 and form a fluid-tight connection within the liquid passageway.

The resilient flow control valve 1004 can include a frame structure 1008 and resilient portion 1018 as described herein. The frame structure 1008 can include a retention structure 1012 disposed on an interior bore of the retention structure 1012. The retention structure 1012 can be a shelf or protrusion that is dimensioned to hold the tubular wall 1014 of the baffle 1006 in place. For example, the shelf of the frame structure 1008 can have an inner diameter 1024 that is less than the diameter 1010 of the baffle 1006. In at least one embodiment, the baffle 1006 is located upstream of the resilient portion 1018 (e.g., towards the upstream side 1016a).

In a second mode of operation, the opening of the baffle 1006 can meter a stream of liquid into the resilient portion 1018 to control the flow rate of the liquid as the liquid is being dispensed into the downstream liquid passageway.

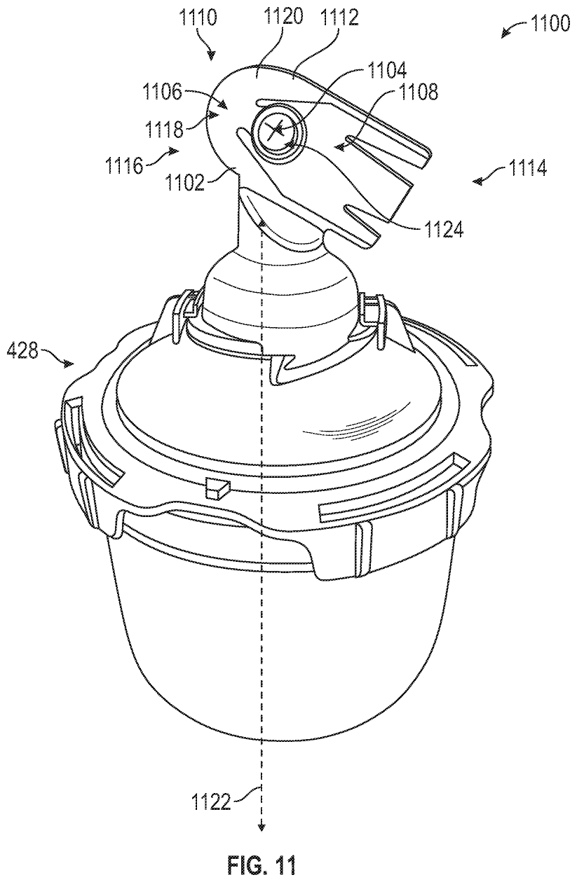

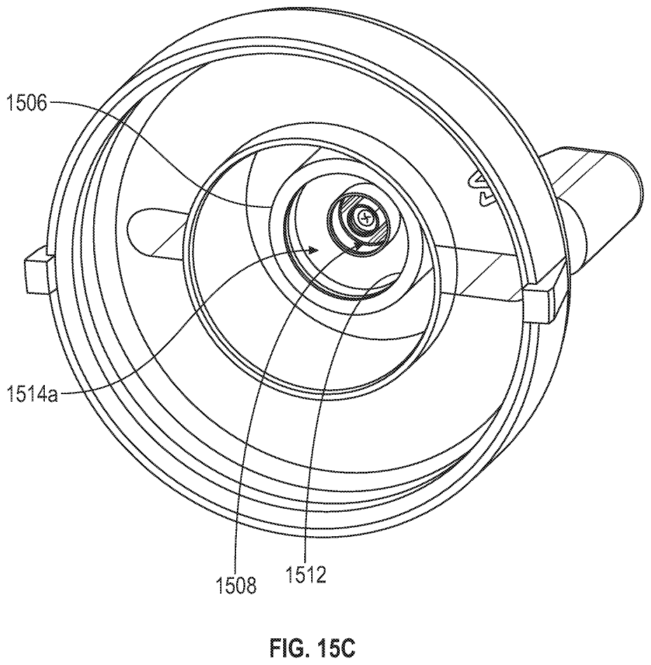

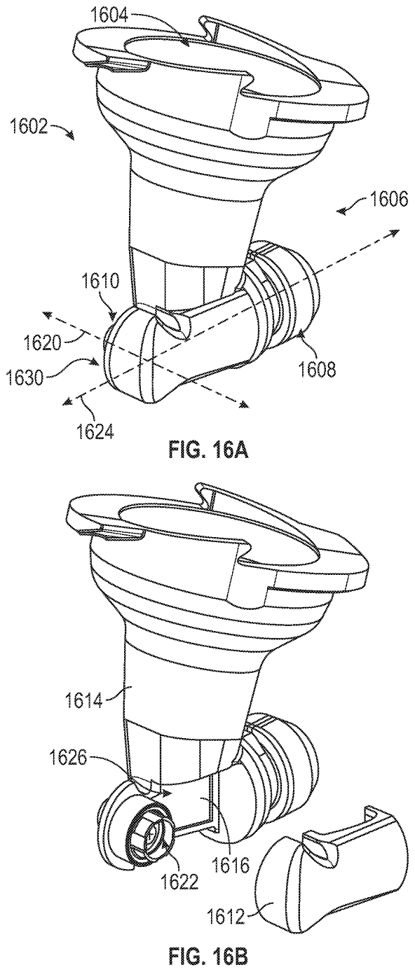

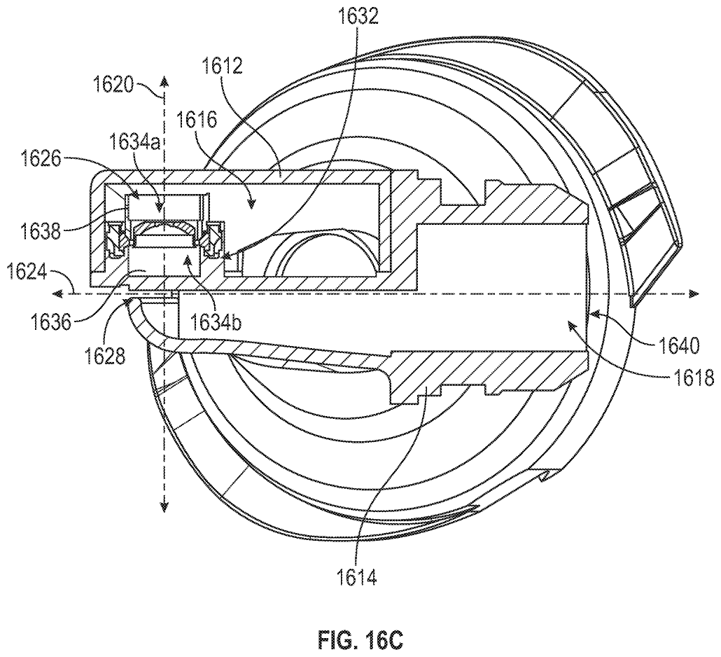

FIG. 11 illustrates an example of system 1100 that includes a liquid reservoir system 428 and nozzle assembly 1110 having a nozzle assembly body 1102. The nozzle assembly body 1102 can be similar to nozzle assembly 1602 in FIG. 16A and FIG. 16B except the removable cover (not shown in FIG. 11) is on the side face 1112.

Thus, the nozzle assembly body 1102 includes a side-mounted liquid passageway 1104 arranged orthogonal to the reservoir axis 1122. The nozzle assembly body 1102 can include an integrated liquid passageway 1104. A resilient flow control valve 1124 can be mounted within the liquid passageway 1104. The liquid reservoir system 428 is releasably connectable to nozzle assembly 1110.

The nozzle assembly body 1102 includes a removable cover (not shown) that attaches over the liquid passageway 1104. The removable cover includes an opening that allows gas to flow from the second end 1114 through gas passageway 1108 formed between the removable cover and the nozzle assembly body 1102 to the first end 1116. The opening can allow liquid from liquid passageway 1104 to be atomized. The shelf 1120 can facilitate the atomization and the liquid and gas can combine at the mixing zone 1118.

In at least one embodiment, the liquid passageway 1104 can be controlled via gas passageway 1108 (within the removable cover) which can be on the side face 1112 of the nozzle assembly body 1102.

The nozzle assembly body 1102 can be releasably coupled to a gas source at the second end 1114. For example, the nozzle assembly body 1102 can be releasably coupled to the removeable cover which is coupled directly to a gas source (not shown). Gas can flow through the gas passageway 1108 and create a pressure differential across the resilient flow control valve 1124 sufficient to cause the resilient flow control valve 1124 to open and allow liquid to flow through the liquid outlet to interact with the gas at the mixing zone 1118.

When actuated by liquid passageway 1104, the gas can flow through the gas passageway 1108 and create negative pressure sufficient to draw in a liquid. The gas and atomized liquid can flow through gas outlet 1106 and mixing zone 1118.

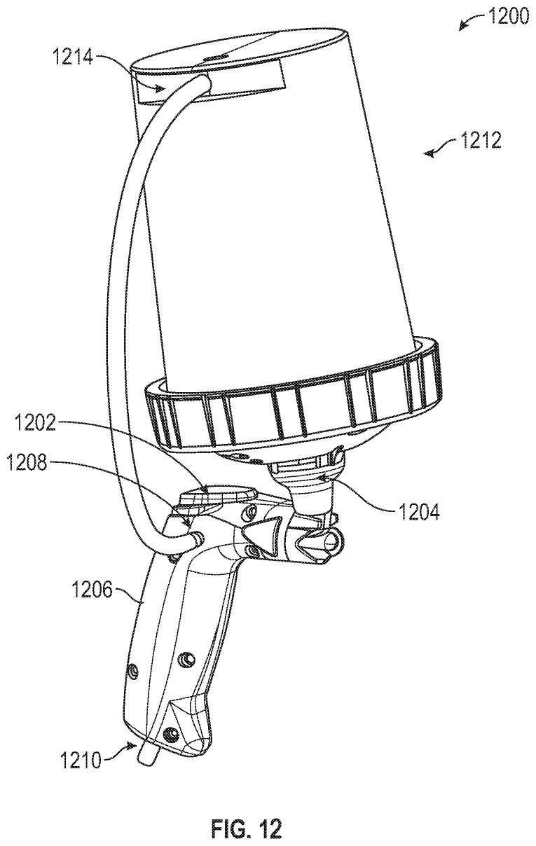

FIG. 12 illustrates a system 1200 configured to pressurize a liquid to be sprayed by the system 1200. The system 1200 can include a pressurizable liquid reservoir system 1212, a nozzle assembly 1204, and spray gun platform 1206. The nozzle assembly 1204 can be similar to the nozzle assembly 304 and nozzle assembly 412 described further herein.

The pressurizable liquid reservoir system 1212 can be similar to commercially available pressurized systems by 3M (Saint Paul, MN) under the trade designation “PPS”, model “Type H/O”.

The spray gun platform 1206 can be similar to spray gun platform 402 except that spray gun platform 1206 can include an auxiliary gas outlet 1208 fluidically coupled to the auxiliary gas inlet 1214 of a pressurizable liquid reservoir system 1212. In a first mode, little to no gas is supplied by the gas source 1210. In a second mode, the user can depress actuator 1202 which triggers a valve and causes gas to flow through auxiliary gas outlet 1208 and into auxiliary gas inlet 1214 (thus pressurizing the pressurizable liquid reservoir system 1212). In at least one embodiment, the actuator 1202 can also trigger the valve which can cause the gas to flow through the nozzle assembly 1204, atomizing the liquid as described herein. In at least one embodiment, the auxiliary gas inlet 1214 can be supplied independent from the spray gun platform 1206.

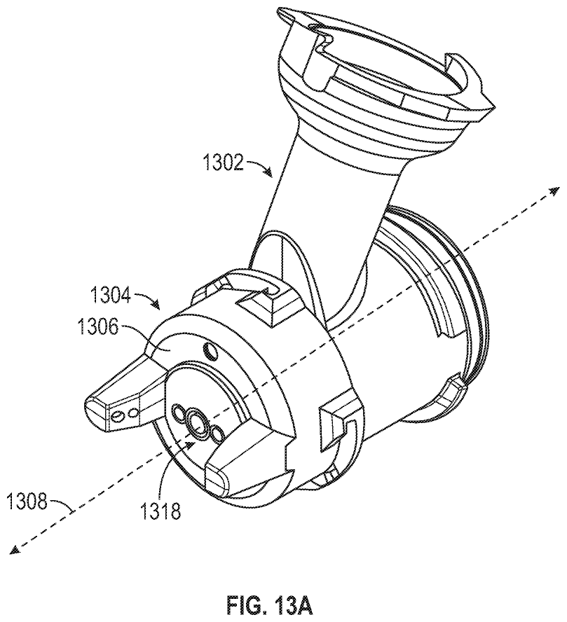

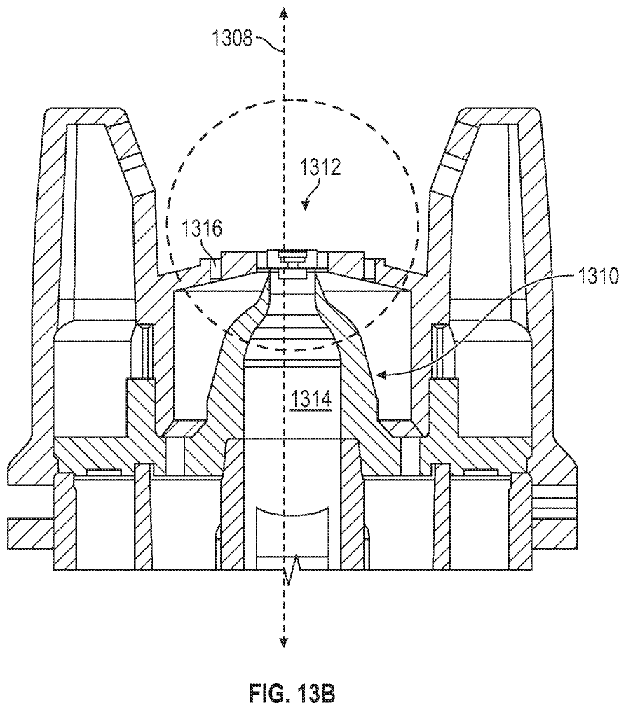

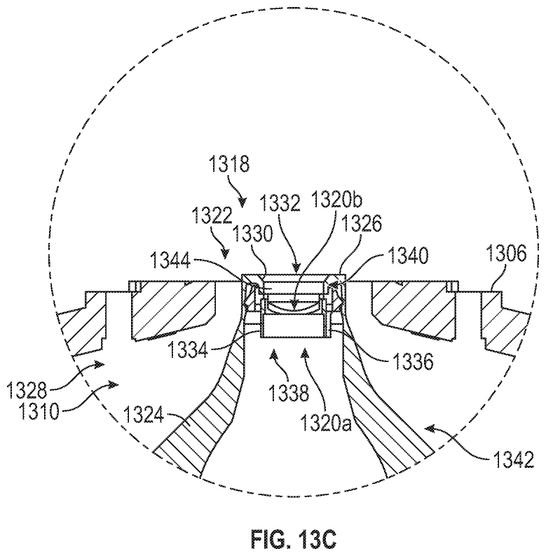

FIG. 13A, FIG. 13B, and FIG. 13C illustrate spray gun components including a nozzle assembly 1302 and an air cap 1304. The nozzle assembly 1302 can be configured to mate with a spray gun platform (not shown). The nozzle assembly 1302 can share some components with the commercially available “3M Performance Spray gun” by 3M (Saint Paul, MN). Although nozzle assembly 1302 may be an example of a nozzle cartridge, the principles can be extended to non-cartridge-based spray systems (e.g., FIG. 1 and FIG. 2).

The air cap 1304 is commercially available from 3M (Saint Paul, MN) and can be configured to mate with a standard spray gun or spray gun nozzle cartridge. The air cap 1304 can have an air cap front wall 1306 with a major opening 1318 formed therein (thus forming part of the gas outlet). The air cap 1304 can also have one or more auxiliary air holes 1316 formed therein adjacent to the major opening 1318. The auxiliary air hole 1316 can improve the resulting spray pattern.

The nozzle assembly 1302 and air cap 1304 can be oriented along the longitudinal axis 1308 when assembled such that the longitudinal axis 1308 passes thru the major opening 1318. The nozzle assembly 1302 can include a nozzle 1310 with a chamber 1314. The nozzle 1310 can be attached to the nozzle assembly 1302.

An aspect of the present embodiment is that the resilient flow control valve 1338 may be positioned adjacent to the liquid outlet 1332 to reduce or minimize the amount of liquid that remains in the downstream of the resilient flow control valve after shutting off the flow of gas by closing the actuator.

As shown in FIG. 13C, the nozzle 1310 can include a nozzle wall 1324 that tapers toward the nozzle tip distal surface 1326 to form a tapered region 1342. The nozzle wall 1324 can form a chamber 1314 on an interior portion of the nozzle wall 1324. The nozzle 1310 can include a resilient flow control valve 1338 mounted near the nozzle tip distal surface 1326.

In at least one embodiment, a retention structure 1340 can be formed within the nozzle wall 1324. For example, a wall can extend inwardly from the nozzle tip distal surface 1326 of the nozzle 1310 and along the longitudinal axis 1308 to form a flange 1330 with the distalmost end of the flange 1330 forming a flange rim 1344.

The nozzle assembly 1302 can include a resilient flow control valve 1338 similar to resilient flow control valves described herein. The resilient flow control valve 1338 can include a frame structure 1336 and have an upstream side 1320a and a downstream side 1320b. The frame structure 1336 can include a resilient flow control valve rim 1334 on the upstream side 1320a. In at least one embodiment, the flange rim 1344 can have an outer radial diameter (measured transverse to the longitudinal axis 1308) that is less than the outer radial diameter of the chamber 1314. The downstream side 1320b of the resilient flow control valve 1338 can mate with the interior of the flange rim 1344 to form a fluid-tight seal between the chamber 1314 and the liquid outlet 1332. This configuration may be advantageous since the resilient flow control valve 1338 may be pushed outwardly along the longitudinal axis 1308 toward the liquid outlet 1332. The flange 1330 can resist the outward opening pressure allowing the resilient flow control valve 1338 to remain fully seated.

In at least one embodiment, the nozzle tip distal surface 1326 of the nozzle 1310 can protrude downstream past a plane established by the air cap front wall 1306 (adjacent to the major opening 1318) (e.g., forming an external-mix spray equipment). An annular opening 1322 can be formed between the nozzle wall 1324 and the air cap front wall 1306 to allow atomizing gas to flow through from the gas passageway 1328. The gas exiting the annular opening 1322 and liquid exiting the liquid outlet 1332 can interact at the mixing zone 1312.

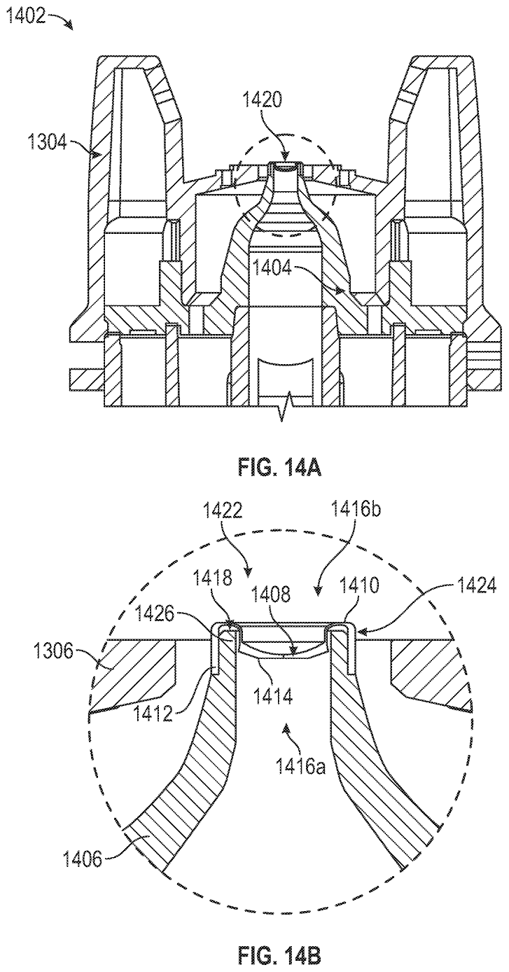

FIG. 14A illustrates a nozzle assembly 1402 configured similar to nozzle assembly 1302 except that the resilient flow control valve 1408 is mounted outside of the nozzle wall 1406 instead of the nozzle wall 1406 having a retention structure. In at least one embodiment, the nozzle assembly 1402 can include a nozzle 1404, a resilient flow control valve 1408, and an air cap 1304 disposed on the nozzle 1404.

FIG. 14B illustrates the resilient flow control valve 1408 in greater detail. For example, the nozzle tip distal surface 1410 of the nozzle 1404 can form an annular rim 1426 that receives the resilient flow control valve 1408 at the downstream side of the rim 1426. The nozzle tip distal surface 1410 can be part of the nozzle 1404.

The resilient flow control valve 1408 can include a frame structure 1412 and resilient portion 1414 like in resilient flow control valve 1338) except that the frame structure 1412 can be configured to include a recessed portion 1418 having a diameter that is complementary to the nozzle tip distal surface 1410. Alternatively, the resilient flow control valve 1408 may be made from a single resilient component which may be stretched to fit over a recessed portion 1418. Thus, the downstream side 1416b of the resilient flow control valve 1338 can cap the nozzle tip distal surface 1410 (and the rim 1426) of the nozzle 1404. Adhesive or other securement can be applied to the recessed portion 1418 to further secure the resilient flow control valve 1408 to the nozzle 1404. The downstream side 1416b of the resilient flow control valve 1408 can be exposed to the atmosphere and can be immediately adjacent to the mixing zone 1420. In at least one embodiment, a resilient flow control valve 1408 may be located at the liquid outlet 1422 such that the outlet of the resilient flow control valve 1408 is directly adjacent to gas outlet 1424 and combined at a mixing zone 1420. In at least one embodiment, the frame structure 1412 does not substantially contact the upstream side 1416a of the nozzle wall 1406.

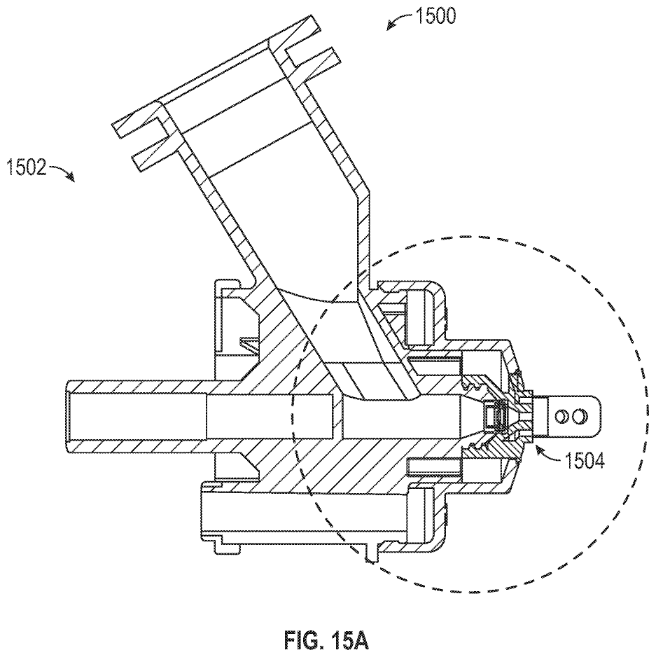

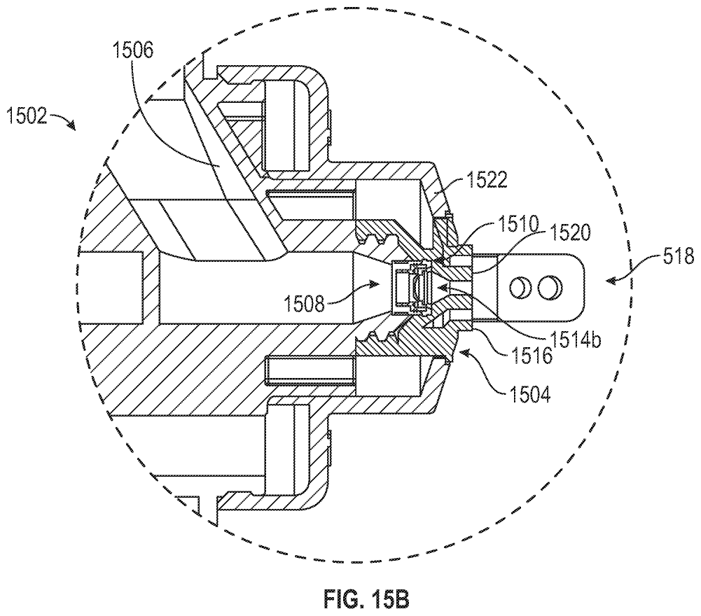

FIG. 15A, FIG. 15B, and FIG. 15C illustrates a nozzle assembly 1502 and an integrated air cap/nozzle 1504 in a spray head assembly 1500. The integrated air cap/nozzle 1504 can be a spray gun component that is attachable to a nozzle assembly 1502 or another spray gun component. The spray head assembly 1500 can be configured similar to the spray head assembly described in U.S. Pat. No. 9,358,561 by Johnson et. al. For example, the nozzle assembly 1502 in FIG. 15B is configured similar to the barrel described in described Johnson et. al. The integrated air cap/nozzle 1504 is configured similar to the integrated air cap/nozzle described Johnson et. al. except that the integrated air cap/nozzle 1504 includes a retention structure 1510 for mating with a resilient flow control valve 1508.

For example, the integrated air cap/nozzle 1504 can include a cap body that includes a nozzle body comprising a nozzle aperture, a nozzle outlet end 1518 located within the nozzle aperture, and a liquid nozzle opening 1520 located within the nozzle outlet end 1518 through which liquid exits during operation of the liquid spray gun system. The integrated air cap/nozzle 1504 can include a center air outlet 1516 located in a gap defined between the nozzle aperture and the nozzle outlet end 1518, through which center air discharges when a liquid is sprayed through the liquid nozzle opening. The liquid nozzle opening and the center air outlet 1516 are formed in a front wall 1522 of the cap body.

The nozzle body inlet end 1506 of the integrated air cap/nozzle 1504 can have an inside surface 1512 for mating with the liquid passageway of the nozzle assembly 1502. The inside surface 1512 can include a retention structure 1510 (shown as a depression dimensioned for receiving the resilient flow control valve 1508). The resilient flow control valve 1508 can be similar to the resilient flow control valve 432 described herein. Further, the resilient flow control valve 1508 can have an upstream side 1514a and a downstream side 1514b. The upstream side 1514a can face upstream of the liquid flow toward a liquid inlet and the downstream side 1514b can face downstream of the liquid flow toward the liquid outlet. The resilient flow control valve 1508 can be placed in the retention structure 1510 such that the downstream side 1514b faces the liquid nozzle opening 1520 and is located adjacent to the liquid nozzle opening 1520 similar to resilient flow control valve 1338.

FIG. 16A, FIG. 16B and FIG. 16C illustrate a nozzle assembly 1602 configured to attach to a spray gun platform. The nozzle assembly 1602 can be similar to nozzle assembly 412 except that the nozzle assembly 1602 is assembled using multiple body portions. For example, the nozzle assembly 1602 can include a nozzle body portion 1612 and a nozzle body portion 1614.

The nozzle assembly 1602 can be oriented along the longitudinal axis 1624. For example, a portion of the gas passageway 1618 (formed between the gas outlet 1628 and the gas inlet 1640) can be aligned along the longitudinal axis 1624 as described in nozzle assembly 412. In at least one embodiment, the retention structure 1608 can be proximate to the gas inlet 1606. However, the resilient flow control valve 1622 can be oriented along the resilient flow control valve axis 1620. In at least one embodiment, the resilient flow control valve axis 1620 is perpendicular to the longitudinal axis 1624. In at least one embodiment, the resilient flow control valve axis 1620 and longitudinal axis 1624 can intersect proximate to the gas outlet 1628. The longitudinal axis 1624 can be defined by the direction of a resulting spray pattern and the resilient flow control valve axis 1620 can be defined by a majority of a cylindrical portion of the resilient flow control valve 1622.

The liquid passageway 1626 (including liquid chamber 1616) can be formed from the combination of the nozzle body portion 1612 and nozzle body portion 1614. In at least one embodiment, the nozzle body portion 1612 can partially form the liquid passageway 1626 in combination with nozzle body portion 1614. The liquid passageway 1626 can extend from the liquid inlet 1604 to the liquid outlet 1610. The gas can be configured to atomize the liquid at the mixing zone 1630 in operation. In at least one embodiment, the nozzle body portion 1614 can include a retention member 1632 formed in the liquid passageway 1626 therein.

The retention member 1632 can engage the with the resilient flow control valve 1622 (e.g., the frame structure 1638). For example, the resilient flow control valve 1622 can be oriented such that the upstream side 1634a faces the upstream of the liquid flow and the downstream side 1634b faces downstream of the liquid flow. The liquid can flow through the liquid inlet 1604, through the liquid passageway 1626, through the resilient flow control valve 1622, and through the liquid diverter 1636. In at least one embodiment, the liquid diverter 1636 can be formed in the nozzle body portion 1614 and configured to direct liquid from the resilient flow control valve 1622 to liquid outlet 1610 and into the mixing zone 1630.

In at least one embodiment, the resilient flow control valve 1622 may be contained between two or more components (nozzle body portion 1612 and nozzle body portion 1614) which are permanently bonded using any of the means previously described or joined using a mechanical fastening mechanism. When combined, the two or more components can form a complete nozzle assembly 1602. In at least one embodiment, the two components (nozzle body portion 1612 and nozzle body portion 1614) can be formed with complimentary sealing features such that the resilient flow control valve 1622 does not use a frame structure (not shown) separate from the nozzle body.

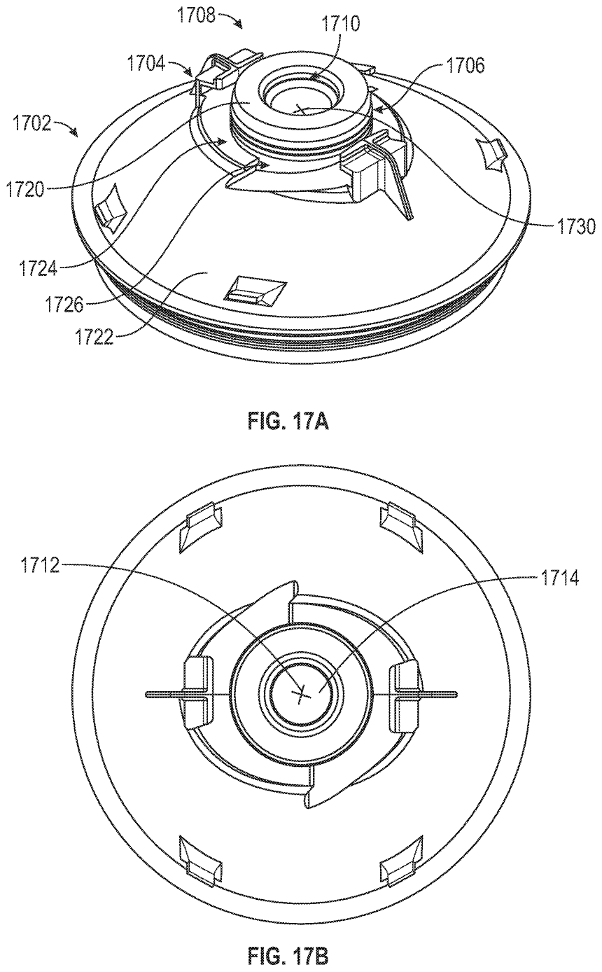

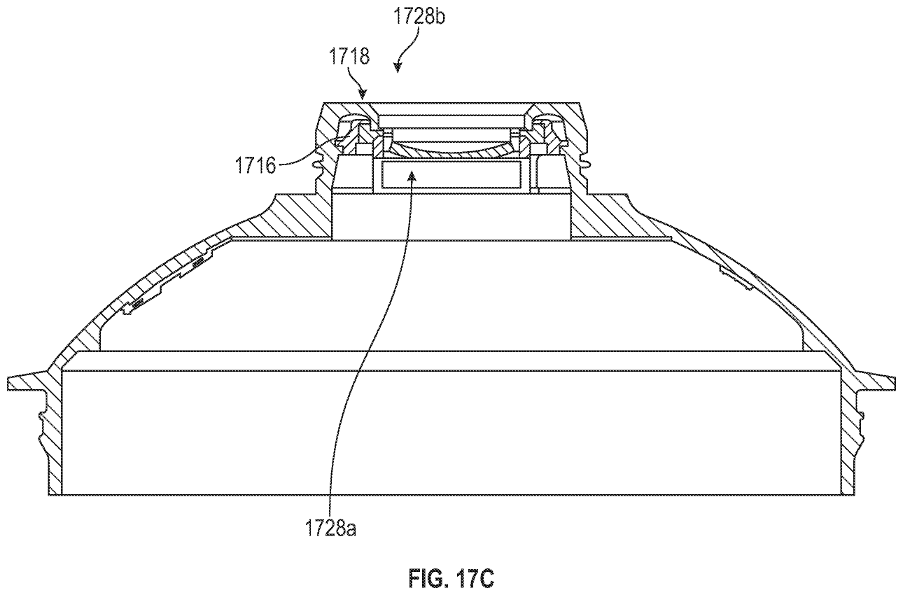

FIG. 17A, FIG. 17B, and FIG. 17C illustrate a liquid reservoir component that is a lid 1702. The lid 1702 can be configured similarly to lid 480 described herein except that lid 1702 includes a resilient portion 1714 disposed therein. The lid 1702 can be configured to couple with a spray gun inlet from a nozzle assembly or spray gun component.

For example, the lid 1702 can have a connection format 1704 that is described in PCT Publication WO2018109594A1 by Hegdahl et al. For example, the lid 1702 can include a lid body with the lid body including a spout 1706, a platform 1724 at least partially surrounding the spout 1706. The platform 1724 can define a major plane and a partial helical shape declining with respect to the major plane and revolving about a central axis of the spout 1706. Although obstructed in FIG. 17A, the platform 1724 is shown as a relatively a flat surface (aligned along the major plane) that transitions to a ramp. The lid 1702 can also include a wall having an outer face 1722 adjoining the platform 1724 and include a portion that is declining with respect to the major plane of the platform 1724. The partial helical shape 1726 begins in the major plane and interrupts the declining portion of the outer face of the wall. The lid 1702 can be configured to directly or indirectly attach to a nozzle assembly or other spray gun component.

In at least one embodiment, the spout 1706 can include a rim 1720 on the distal surface which defines the liquid outlet 1708. The resilient flow control valve 1710 can be coupled to the spout 1706 in a similar manner to the resilient flow control valve 1338) coupling to the nozzle tip distal surface 1326 in FIG. 13C.

For example, the lid 1702 can include a retention structure 1718 positioned adjacent to the rim 1720 with the upstream side 1728a facing toward the liquid in the liquid reservoir system (not shown) and the downstream side 1728b oriented toward the downstream (i.e., toward the liquid inlet of a nozzle assembly or another spray gun component). The retention structure 1718 can include a flange configured to couple with the frame structure 1716 of the resilient flow control valve 1710 to form a fluid-tight fitment with the lid 1702. As the one or more slits 1730 of the resilient portion 1714 opens toward the downstream side 1728b (to form opening 1712) due to a differential pressure that surpasses an opening pressure, liquid (if present) is dispensed from the opening 1712, and the liquid can proceed into a liquid inlet of a nozzle assembly or another spray gun component when the lid 1702 is attached thereon.

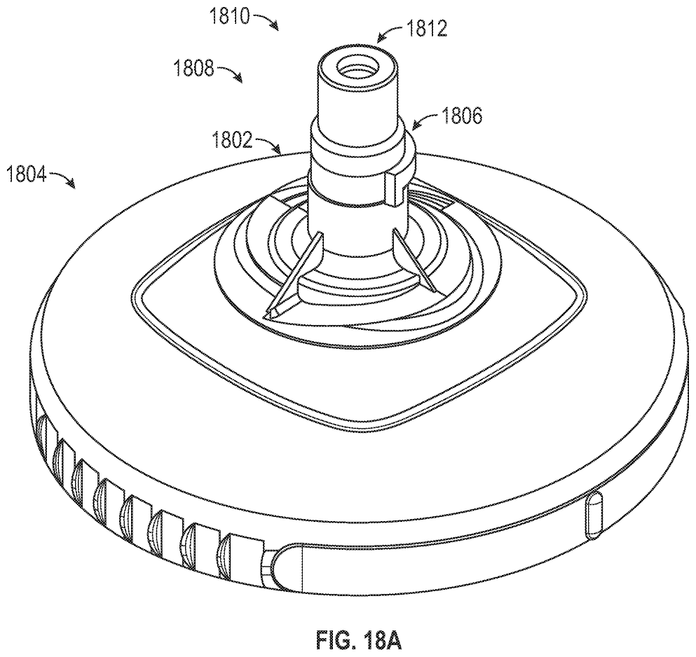

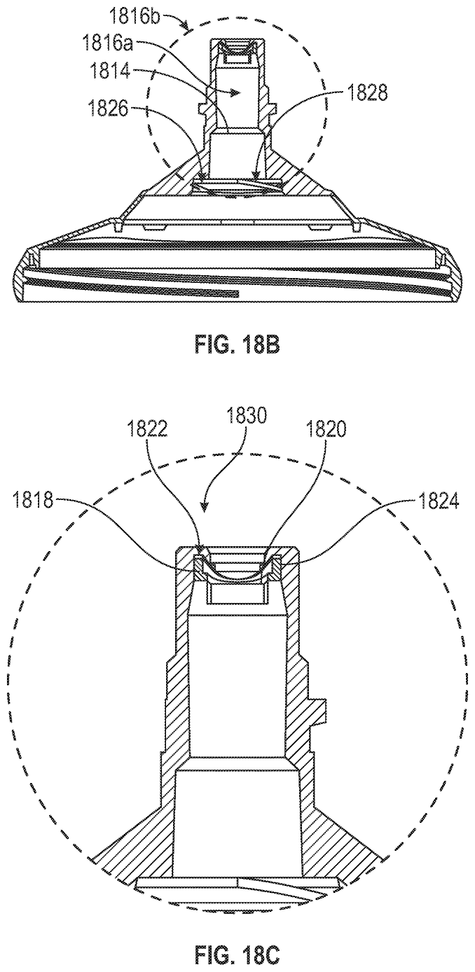

FIG. 18A, FIG. 18B, and FIG. 18C illustrate an embodiment of a liquid reservoir component that is an adaptor 1802 coupled to a lid 1804. In at least one embodiment, the adaptor 1802 can include the resilient flow control valve 1812 and can fit onto the lid 1804.

The lid 1804 can include a lid spout 1828 and a connection feature 1826 disposed thereon.

The adaptor 1802 can have a complementary connection format 1806 to connection feature 1826 which can connect to a spray gun platform or nozzle assembly. The adaptor 1802 can fit over the lid spout 1828 of the lid 1804. The connection format 1806 shown is similar to that described in FIG. 52, PCT Publication WO 2004/037433 to Joseph et al. For example, the adaptor 1802 can have an integral outlet for direct connection to a bushing of a spray gun platform or nozzle assembly. The liquid outlet 1810 can have a cylindrical portion (e.g., adaptor spout 1808) provided with a helical projection (e.g., connection format 1806) for cooperating with an attachment on a spray gun platform or nozzle assembly body. The connection format 1806 can also include a bearing/raised feature provided at one end of the helical projection to form an end stop and limit rotation of the adaptor 1802 and/or lid 1804 relative to the connection format 1806.

In at least one embodiment, the adaptor 1802 can also include a resilient flow control valve 1812 having an upstream side 1816a and downstream side 1816b. The resilient flow control valve 1812 can be attached to the adaptor 1802 in a similar manner as resilient flow control valve 1710 to spout 1706. For example, the adaptor spout 1808 of adaptor 1802 can include a distal surface 1830 and an interior surface 1814. The distal surface 1830 can form a retention structure 1822 to engage with the downstream side 1816b of resilient flow control valve 1710 described herein. The resilient flow control valve 1710 can include a frame structure 1818, and resilient portion 1820. In at least one embodiment, the side wall 1824 of the frame structure 1818 can contact the interior surface 1814 so that no gap is formed between the side wall 1824 and the interior surface 1814. This configuration can reduce the liquid that can accumulate at a distal end of the adaptor spout 1808.

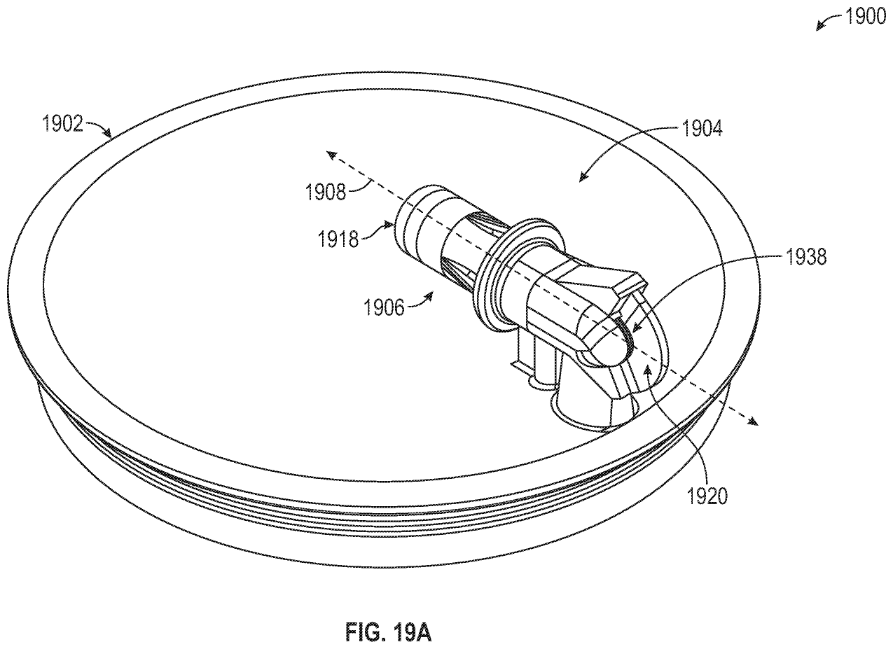

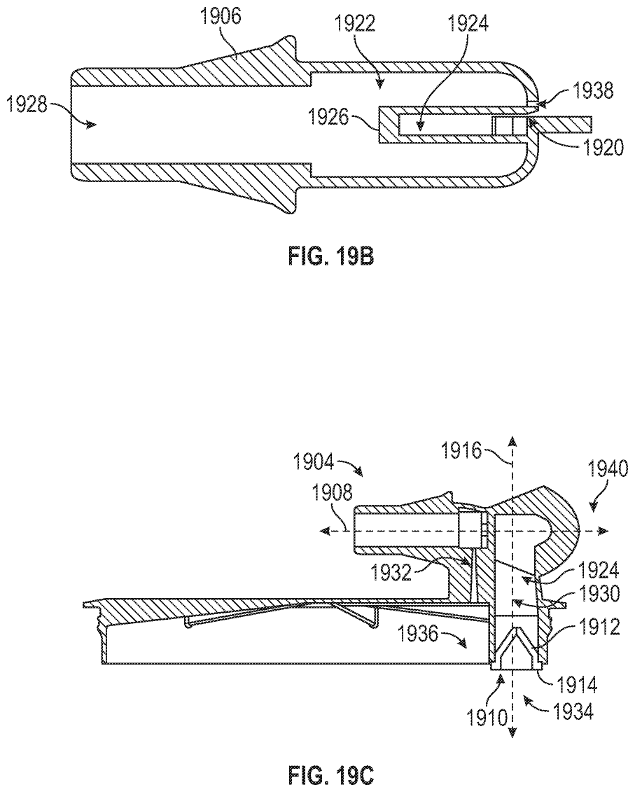

FIG. 19A, FIG. 19B, and FIG. 19C illustrate an integrated lid/nozzle 1900. The integrated lid/nozzle 1900 can include a lid 1902 formed integrally with a nozzle assembly body 1904. The integrated lid/nozzle 1900 can also include the resilient flow control valve 1910 similar to integrated lid/nozzle 702 in FIG. 7A and FIG. 7B except that the liquid passageway 1924 is positioned adjacent to the liquid outlet 1920.

For example, the nozzle assembly body 1904 can include a gas inlet 1918 and gas outlet 1938 forming a gas passageway 1922. The nozzle assembly body 1904 can include a liquid inlet 1934 and liquid outlet 1920 forming a liquid passageway 1924. In at least one embodiment, an interior wall 1926 partially spaced apart from the tubular wall 1906 can form at least part of the liquid passageway 1924. The liquid can be transported from the liquid inlet 1934 to the liquid outlet 1920 via the liquid passageway 1924.

The nozzle assembly body 1904 can include a tubular wall 1906 forming the gas inlet 1918 (coaxial with longitudinal axis 1908). In at least one embodiment, the longitudinal axis 1908 can be adjustable from 90 degrees to 180 degrees with respect to liquid flow axis 1916.

In at least one embodiment, the resilient flow control valve 1910 can be adjacent to the liquid inlet 1934. The resilient flow control valve 1910 can include the attachment structure 1914 and resilient portion 1912 formed from a single component. Thus, the resilient flow control valve 1910 may lack a frame structure as described herein. The attachment structure 1914 can include an integral flange which forms a seal with respect to the liquid inlet 1934 and seals the opening in the liquid inlet 1934. As shown, the resilient portion 1912 can be a duckbill valve. The resilient flow control valve 1910 can lead into the downstream liquid chamber 1930. In a second mode, the resilient portion 1912 can be configured to change into an open configuration in response to gas flowing through the gas outlet 1938 and causing a differential pressure across the resilient portion 1912 to be at least the opening pressure of the resilient portion 1912. Any liquid, located within an attached compatible cup (not shown), can be dispensed in response to the open configuration and can be atomized at a mixing zone 1940.

In at least one embodiment, a boost passageway 1932 can be formed within the nozzle assembly body 1904 such that the chamber 1928 of the gas passageway 1922 is fluidically coupled to the lid chamber 1936 separate from the liquid passageway 1924. The boost passageway 1932 can be described in U.S. Pat. No. 9,802,213 to Joseph et al.

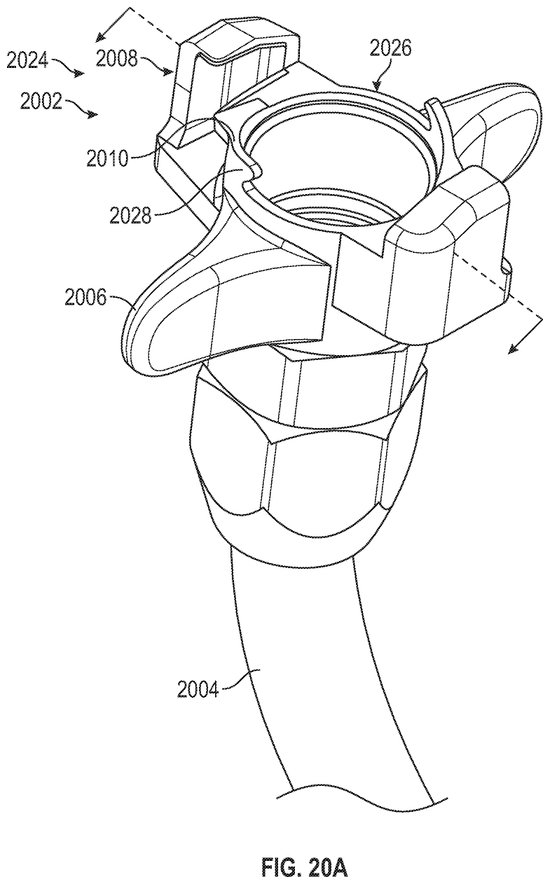

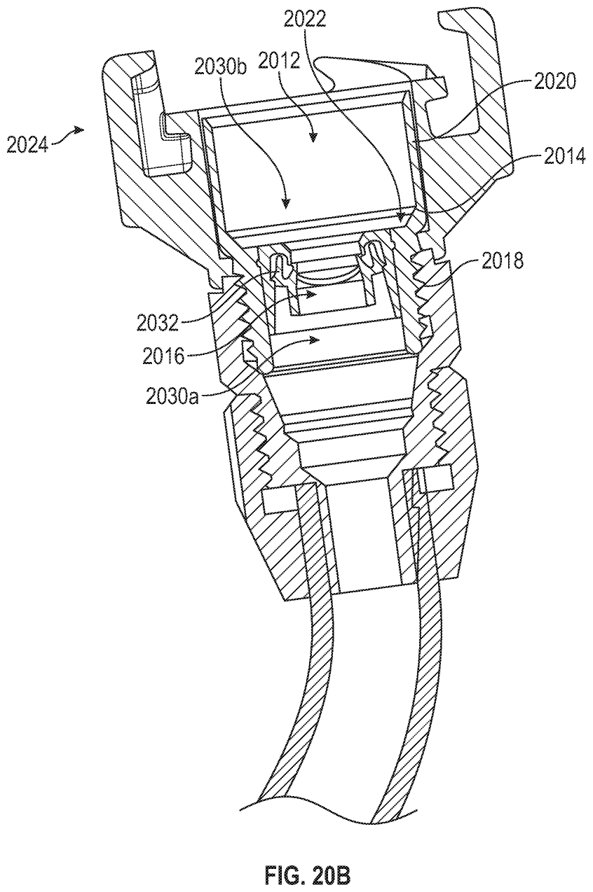

FIG. 20A and FIG. 20B illustrate a liquid hose assembly 2002. The liquid hose assembly 2002 can be a spray gun component for attachment to a nozzle assembly or spray gun platform in a pressure-fed configuration (as opposed to gravity-fed described in FIG. 1). The liquid hose assembly 2002 can include a supply hose 2004 and an adaptor 2024 with a connection format 2026 configured to releasably mate with a complementary connection format of the spray gun platform or nozzle assembly.

The connection format 2026 can be commercially available under the trade designation “Performance Spray Gun Pressure Whip” by 3M (Saint Paul, MN), part number 26833. For example, the connection format 2026 can include a tracking face 2010 and a lock structure 2028. The lock structure 2028 is configured to selectively interface with complementary structures on the spray gun platform or nozzle assembly. The adaptor 2024 can also include an arm 2008 that can further retain the adaptor 2024 on the spray gun platform or nozzle assembly. The adaptor 2024 can also include a grasping section 2006 that can allow a user to easily perform a quick-connect operation to attach the adaptor 2024 to a spray gun platform.

In at least one embodiment, the adaptor 2024 can include a tubular member 2020. The tubular member 2020 can form a chamber 2012 for sealing with a spout on the spray gun platform. A distal surface of the spout can engage with the sealing surface 2014 of the chamber 2012 and held in place by the connection format 2026.

The tubular member 2020 can form a retention structure 2022 upstream of the sealing surface 2014 in a similar manner to retention structure 1340 in FIG. 13C, retention structure 1718 in FIG. 17C, and retention structure 1822 and FIG. 18C. For example, the retention structure 2022 can hold the resilient flow control valve 2016 in the direction of the downstream side 2030b such that fluid pressure from the upstream side 2030a does not cause the resilient flow control valve 2016 to dislodge downstream. In at least one embodiment, the tubular member 2020 can be machined from metal and the frame structure 2032 can lock into a groove at retention structure 2022. In at least one embodiment, the tubular member 2020 can have exterior threads 2018 to attach to the supply hose 2004.

“Across” refers to between two opposing major surfaces. For example, between an upstream side and a downstream side of a resilient flow control valve.

“Actuator” refers to a device or mechanism that is configured to manually control a gas valve from outside a gas valve body and/or outside of a spray gun body, or a spray gun component body. The term actuator can also include a button or a trigger structure.

“Atmosphere” refers to conditions (atmospheric pressure, temperature, etc.) surrounding the spray gun system.

“Atmospheric pressure” refers to pressure exerted by the atmosphere on the spray gun system.

“Body” refers to a material form of an object.

“Closed” refers to a state of the resilient flow control valve in which no liquid flows, when liquid is on an upstream side of the resilient flow control valve.

“Closed configuration” refers to a configuration of the resilient flow control valve that does not allow passage of a liquid from the upstream side of the resilient flow control valve to a downstream side when liquid is present on the upstream side. Closed configuration can include an unopened slit(s) or self-sealing flaps within the resilient portion.

“Closing pressure” refers to the pressure at or below which a resilient flow control valve will transition from an open configuration to a closed configuration. The closing pressure and the opening pressure can be different values.

“Differential pressure” refers to a difference in pressure between an upstream (P1) and downstream (P2) location. It can be expressed as ΔP=P1−P2.

“Downstream liquid chamber” refers to a chamber that is downstream from the resilient flow control valve. The downstream liquid chamber can be configured to facilitate negative fluid pressure in response to the presence of fluid flow in the gas passageway.

“Downstream side” refers to a side that is downstream from a resilient portion.

“Elastomeric” refers to natural or synthetic polymers, such as natural or synthetic rubber, that display viscoelastic behavior under deformation, have a low modulus of elasticity (e.g., no greater than 0.5 GPa), and a high failure strain.

“Fluid-tight” refers to prohibiting the entrance of fluids such as water at appropriate operating pressures of a spray gun system. In at least one embodiment, the liquid can be at pressures no greater than 50 pounds per square inch.

“Gas” refers to a substance or matter in a state in which it will expand freely to fill the whole of a container, having no fixed shape (unlike a solid) and no fixed volume (unlike a liquid). The gas can be used in a spraying process to atomize a bulk liquid and form a spray pattern. The gas can be used as a carrier for the liquid to assist in delivery of the fluid. Examples of gases include nitrogen, carbon dioxide, gas mixtures such as air, and even gas propellants which may be in a gaseous state at standard pressure but liquified at higher pressures.

“Gas valve” refers to a device to control, direct, or regulate flow of the gas (and can indirectly control, direct, or regulate flow of the liquid by changing the differential pressure across a resilient flow control valve described herein) in a binary or graduated manner. Examples of a gas valve can include gate valves, poppet valves, butterfly valves, ball valves and the like.

“Grip portion” refers to a section that is configured to be gripped by a user's hand.

“Linear” refers to arranged in or extending along a straight or nearly straight line.

“Liquid” refers to coating materials that can be applied to a surface using a spray gun system including (without limitation) paints, primers, base coats, lacquers, varnishes and similar paint-like materials as well as other materials such as adhesives, sealers, fillers, putties, powder coatings, blasting powders, abrasive slurries, mold release agents and foundry dressings which may be applied in atomized or non-atomized form depending on the properties and/or the intended application of the material. In these applications, the term liquid is used generically as it may include solid particles (pigments, powders, granules, etc.) which are suspended or dissolved in a carrier liquid.

“Liquid outlet” refers to a location where a liquid exits a spray gun component, or would exit the spray gun component without interference from a resilient flow control valve. For example, the resilient flow control valve can be installed on the liquid outlet of a spray gun component and form a portion of the liquid outlet. In at least one embodiment, the liquid outlet can be at least partially formed at a distal end of a spray gun component.

“Liquid passageway” refers to a liquid flow path within the spray gun component body.

“Liquid reservoir component” refers to a component within a liquid reservoir system. Examples of liquid reservoir components include lids, containers, cups, pouches, bags, adapters, and liquid hose assemblies.

“Liquid reservoir system” refers to a system configured to hold or transport a liquid. The liquid reservoir system can include at least a liquid reservoir component. The liquid reservoir system can include a plurality of liquid reservoir components such as a cup, and a lid. The liquid reservoir system can also include components such as liquid hose assemblies that are fluidically coupled to a drum. The liquid reservoir system can be a type of liquid source.

“Manually-operated valve” refers to a valve capable of being controlled via a mechanical linkage to an actuator. For example, the manually-operated valve can be mechanically coupled to another component such as a trigger of a spray gun platform. The manually-operated valve can translate along the spray longitudinal axis. Examples of manually-operated valves include poppet, globe valve, gate valve, ball valve, butterfly valve, plug valve, slide valve, a needle valve, a lever, or a pinch-valve. The term “manually-operated valve” excludes the resilient flow control valve. For example, even though a slit in a resilient portion can be pushed with manual pressure, the resilient flow control valve is not a “manually-operated valve” because the primary and/or intended mechanism is based on differential pressure, not manual activity.

“Mixing zone” refers to where a stream of gas exits a gas outlet and merges, interacts with, intersects, and/or atomizes a stream of liquid from a liquid outlet.

“Nozzle assembly” refers to a fluid nozzle and a device for coupling the fluid nozzle to a spray gun platform. The nozzle assembly acts to transport a gas through a gas passageway and/or transport a liquid through a liquid passageway formed therein. The gas passageway and/or the liquid passageway of the nozzle assembly is mateable with the gas passageway and/or the liquid passageway of the spray gun platform. In at least one embodiment, the nozzle assembly can include a nozzle cartridge.

“Nozzle cartridge” refers to a spray gun component having a liquid passageway for direct connection to a liquid source/liquid reservoir system and a liquid outlet. When combined with a spray gun platform, the spray gun platform itself does not include the liquid passageway but the spray gun platform can include a portion of a gas passageway for connection to the gas source.

Nozzle cartridge can refer to a type of nozzle assembly.

“Open” refers to any state that allows some liquid to flow across a resilient flow control valve when liquid is present on the upstream side. For example, open can refer to partially-open.

“Open configuration” refers to a configuration that allows passage of a liquid from the upstream side to the downstream side when liquid is present at the upstream side.

“Opening dimension” refers to the largest dimension of an opening of the resilient flow control valve.

“Opening pressure” refers to a differential pressure capable of opening a resilient portion of a resilient flow control valve. Opening pressure is synonymous with cracking pressure.

“Resilient” refers to a material's ability to absorb energy upon elastic deformation, and release that energy upon unloading. Upon unloading, the material will return to its initial state.

Elastomeric materials can be resilient.

“Resilient flow control valve” refers to a valve that operably controls the flow of a liquid having the ability to adjust its degree of openness based upon variations in differential pressure, and the resiliency to remain in a normally-closed configuration once a pre-determined closing differential pressure is achieved. The term “resilient flow control valve” can be used to refer to the resilient portion or any component of the resilient flow control valve.

“Resilient portion” refers to a portion of the resilient flow control valve that controls flow of a liquid. The resilient portion is configured to change between an open configuration and a closed configuration based on a differential pressure across the resilient portion relative to an opening pressure of the resilient portion. The resilient portion can be elastomeric but may utilize rigid or semi-rigid layers.

“Rigid” is used to refer to materials that are not easily deformed/flexible. In one example, rigid materials can be described as having a “stiffness”, or a modulus of elasticity of at least 0.5 GPa.

“Spray equipment” refers to any equipment or component that is used to convey, store, or atomize bulk fluids into a fine spray or mist of droplets. Spray equipment can refer to devices that use air spray, airless, rotary/centrifugal, ultrasonic, or electrostatic methods.

“Spray gun” refers to a type of spray equipment. Spray gun can refer to an air spray gun that uses a low-pressure liquid stream mixed with compressed gas to atomize the liquid in a controlled manner.

“Spray gun component” refers to a component that forms part of a spray gun system. Examples of spray gun components include a spray gun platform, valve, nozzle assembly, nozzle cartridge, air cap, liquid reservoir system and liquid reservoir components thereof. The spray gun component can also include any device that physically attaches to any of the aforementioned spray gun components.

“Spray gun platform” refers to a spray gun component that has a grip portion, actuator and connections to the gas source and optionally a liquid reservoir system. In at least one embodiment, the spray gun platform may refer to a spray gun body with an integrated liquid inlet. In at least one embodiment, the spray gun platform can manually couple to a nozzle cartridge or nozzle assembly.

“Spray gun system” refers to one or more spray gun components that, when assembled together, are configured to atomize a liquid and/or shape it into a spray. The spray gun system can use air to atomize a liquid. The spray gun can be a manual spray gun system or can be robotic, meaning attached to a robotic arm.

“Tapered region” refers to a region that is tapering from a first dimension to a second dimension. The second dimension is less than the first dimension. Dimensions can include a diameter, or perimeter and can be generally indicative of bore or opening size.

“Tubular” refers to a long, round, and hollow shape. Tubular can refer to an ellipsoidal, polygonal cross-section.

“Upstream side” refers to a side that is upstream from a resilient portion.

1. A spray gun component for use in a spray gun system, comprising:
a spray gun component body, the spray gun component body further comprising:
a liquid inlet and a liquid outlet, wherein a liquid passageway is formed between the liquid inlet and liquid outlet;
at least a portion of a resilient flow control valve is disposed within the liquid passageway, the resilient flow control valve having an upstream side and a downstream side, the upstream side is configured to be in fluid communication with the liquid inlet and the downstream side is in fluid communication with atmosphere;
wherein, in a first mode, a differential pressure across the resilient flow control valve is less than an opening pressure of the resilient flow control valve and results in a closed configuration;
wherein, in a second mode, gas flow from the spray gun system causes the differential pressure across the resilient flow control valve to be at least the opening pressure of the resilient flow control valve and thereby causes the resilient flow control valve to change to an open configuration;
wherein the liquid outlet opens to a mixing zone outside of the spray gun component, where gas and liquid interact.

2. The spray gun component of claim 1, wherein the spray gun system does not use a needle valve within the liquid passageway to control the flow of liquid.

3. The spray gun component of claim 1, wherein the only device for controlling a passage of fluid between the liquid inlet and the liquid outlet is one or more resilient flow control valves.

4. The spray gun component of claim 1, wherein the spray gun system is not configured to operate with a manually-operated valve that seals the liquid passageway from the atmosphere in the first mode or unseals the liquid passageway from the atmosphere in the second mode.

5. The spray gun component of claim wherein the resilient flow control valve is disposed proximate to the liquid outlet.

6. The spray gun component of claim 1, wherein the resilient flow control valve is configured to close when the differential pressure across the resilient flow control valve is less than a closing pressure of the resilient flow control valve.

7. The spray gun component of claim 1, wherein the downstream side of the resilient flow control valve is below atmospheric pressure in the second mode.

8. The spray gun component of claim 1, wherein pressure on the upstream side of the resilient flow control valve is augmented by gas pressure from a compatible spray gun body or a gas source.

9. The spray gun component of claim 1, further comprising a gas inlet and a gas outlet, wherein a gas passageway is formed between the gas inlet and gas outlet therein.

10. The spray gun component of claim 1, wherein the liquid passageway further comprises a retention structure configured to engage with the resilient flow control valve.

11. The spray gun component of claim 10, wherein the resilient flow control valve comprises a frame structure and a resilient portion attached to the frame structure, wherein the frame structure is configured to mate with the retention structure.

12. The spray gun component of claim 11, wherein the resilient portion comprises at least one self-sealing opening formed therein.

13. The spray gun component of claim 12, wherein the self-sealing opening is formed by a slit, a cross, or a star-shaped pattern formed in the resilient portion.

14. A kit comprising at least the spray gun component of claim 1.

15. A method of using the spray gun component of claim 1, wherein the spray gun component is a nozzle assembly body, the method comprising:
obtaining a spray gun system that comprises the nozzle assembly body having a liquid inlet and a liquid outlet that form a liquid passageway and a gas inlet and a gas outlet that form a gas passageway, wherein the liquid outlet and gas outlet are configured to intersect at a mixing zone adjacent to the liquid outlet and the gas outlet, wherein a resilient flow control valve is disposed within the liquid passageway in a fluid-tight manner, wherein the spray gun system is coupled to a gas source that is controlled by an actuator;
activating the actuator thus allowing gas to flow through the gas passageway and through the gas outlet;
in response to activating the actuator, the flow of gas induces a change in a differential pressure across the resilient flow control valve, the differential pressure exceeds an opening pressure of the resilient flow control valve and thereby causes the resilient flow control valve to change to an open configuration;
deactivating the actuator thus reducing the flow of gas through the gas passageway and reducing the differential pressure across the resilient flow control valve to no greater than a closing pressure of the resilient flow control valve thereby causing the resilient flow control valve to change to a closed configuration.

16. The method of claim 15, further comprising:
assembling the spray gun system by attaching the nozzle assembly body to a spray gun platform, the spray gun platform comprises a second gas passageway that couples with the gas passageway in the nozzle assembly body, the liquid passageway in the nozzle assembly body is separate from the gas passageway and the second gas passageway.

17. A nozzle assembly, comprising:
a nozzle assembly body, the nozzle assembly body further comprising:
a gas passageway and a liquid passageway formed therein, the liquid passageway is formed between a liquid inlet and a liquid outlet, wherein the liquid passageway is configured to fluidically couple to a liquid reservoir system configured to contain a liquid and the gas passageway is configured to fluidically couple to a gas source;
wherein a resilient flow control valve is disposed within the liquid passageway, the resilient flow control valve having an upstream side and a downstream side, the upstream side is in fluid communication with the liquid reservoir system and the downstream side is in fluid communication with the liquid outlet;
wherein gas flow through the gas passageway opens the resilient flow control valve in response to a difference in pressure across the first and second sides being at least an opening pressure of the resilient flow control valve, thus allowing the resilient flow control valve to open.

18. The nozzle assembly of claim 17, wherein the nozzle assembly is capable of being disassembled from a spray gun platform and retain a fluid-tight seal between atmosphere and contents of a liquid reservoir system.

19. A lid for a liquid reservoir system, comprising:
a lid body having a liquid inlet and a liquid outlet, the liquid inlet is configured to connect to a compatible cup and the liquid outlet configured to connect to a compatible spray gun system, a liquid passageway is formed in the lid body and fluidically connects the liquid inlet and the liquid outlet;
wherein a resilient flow control valve is disposed within the liquid passageway, the resilient flow control valve having a first side and a second side, the first side is in fluid communication with the liquid inlet and the second side is in fluid communication with the liquid outlet;
wherein gas flow through the compatible liquid spray gun system opens the resilient flow control valve when a difference in pressure across the first and second sides is equal to or exceeds an opening pressure of the resilient flow control valve.

20. The lid of claim 19, further comprising a spout that forms a portion of the liquid passageway, the spout has an interior surface having a retention structure disposed thereon configured to engage with the resilient flow control valve.
